(19) United States
(12) Patent Application Publication
(10) Pub. No.: US 2016/0078247 A1
(43) Pub. Date: Mar. 17, 2016

(54) SECURITY EVALUATION SYSTEMS AND METHODS FOR SECURE DOCUMENT CONTROL

(71) Applicant: Temporal Defense Systems, Inc., Renton, WA (US)

(72) Inventors: Mark TUCKER, Kirkland, WA (US); Charles ELDEN, Dunnellon (FL); Jared KARRO, Charlotte, NC (US); Ronald Lance Justin, Santa Barbara, CA (US)

(21) Appl. No.: 14/855,196

(22) Filed: Sep. 15, 2015

Related U.S. Application Data
(60) Provisional application No. 62/051,251, filed on Sep. 16, 2014.
(60) Provisional application No. 62/078,143, filed on Nov. 11, 2014.

(51) Int. Cl. G06F 21/62; G06F 21/60; G06F 17/30; G06F 21/57

(52) U.S. Cl. CPC G06F 21/6218; G06F 21/57; G06F 21/602; G06F 17/30011

(57) ABSTRACT

A system may be broken down into one or more components. Each of the components may be evaluated to ascribe a security score to each of the components. A composite security score may be generated for the system based on the security scores and a rate of decay measure characterizing a probabilistic security degradation of the system. The rate of decay measure may be applied to the composite security score to obtain a current composite security score. The composite security score may be used to control access to a document, either alone or in addition to other criteria.

### CROSS-REFERENCE TO RELATED APPLICATION

This disclosure claims priority from U.S. Provisional Application No. 62/051,251, entitled “Leveraging Security Metrics for Document Control,” filed Sep. 16, 2014 and U.S. Provisional Application No.62/078,143, entitled “Secure Transaction Ecosystem,” filed Nov. 11, 2014; the entirety of each of which is incorporated by reference herein. U.S. patent application Ser. No. 14/523,577, entitled “Autonomous Control Systems and Methods,” filed Oct. 24, 2014 and U.S. patent application Ser. No. 14/634,562, entitled “Security Evaluation Systems and Methods,” filed Feb. 27, 2015 are also incorporated by reference in their entirety herein.

### BRIEF DESCRIPTION OF THE DRAWINGS

FIG. 1 is a security module according to an embodiment of the invention.

FIG. 2 is a security score derivation according to an embodiment of the invention.

FIG. 3 is an asset according to an embodiment of the invention.

FIG. 4 is an asset evaluation according to an embodiment of the invention.

FIGS. 5A-5D are asset subdivisions according to embodiments of the invention.

FIG. 6 is a base security score certificate according to an embodiment of the invention.

FIG. 7 is a base security score certificate according to an embodiment of the invention.

FIG. 8 is a security score degradation according to an embodiment of the invention.

FIG. 9 is a security requirements certificate according to an embodiment of the invention.

FIG. 10 is a base security score certificate according to an embodiment of the invention.

FIG. 11 is a security requirements certificate according to an embodiment of the invention.

FIG. 12 is a normalized security score comparison according to an embodiment of the invention.

FIG. 13 is a normalized security score comparison according to an embodiment of the invention.

FIG. 14 is a security verification according to an embodiment of the invention.

FIG. 15 is a security comparison according to an embodiment of the invention.

FIG. 16 is a security verification according to an embodiment of the invention.

FIG. 17 is a mutual security verification according to an embodiment of the invention.

FIG. 18 is a security verification according to an embodiment of the invention.

FIG. 19 is a security verification according to an embodiment of the invention.

FIG. 20 is a security verification according to an embodiment of the invention.

FIG. 21 is a security verification according to an embodiment of the invention.

FIG. 22 is an enhanced security requirements certificate according to an embodiment of the invention.

FIG. 23 is a protected document according to an embodiment of the invention.

FIGS. 24A-24B are security verifications according to an embodiment of the invention.

FIG. 25 is a security verification according to an embodiment of the invention.

FIG. 26 is a protected document according to an embodiment of the invention.

FIG. 27 is a protected document according to an embodiment of the invention.

FIG. 28 is an example lens system according to an embodiment of the invention.

FIG. 29 is a secure transaction ecosystem according to an embodiment of the invention.

### DETAILED DESCRIPTION OF SEVERAL EMBODIMENTS

Controlling and securing information may be difficult because content owners lose control of a document whenever they send or give the document to anyone else. Systems and methods described herein may secure documents to ensure access to the documents and/or information contained therein is restricted only to those authorized to access it. Unauthorized viewing, printing, and/or editing of documents may be restricted and/or prevented. For example, network printers, which may be shared by multiple individuals, may provide differing levels of access to sensitive information. The systems and methods described herein may be used to secure network printers to prevent unauthorized document printing. Additionally, the systems and methods described herein may secure other devices that can access documents (e.g., PCs, smartphones, scanners, etc.) to prevent unauthorized document access of any kind Document control may foster compliance not only with enterprise/organizational security policies, but also with legal confidentiality standards, for example.

Documents protected by the disclosed systems and methods may include any electronic or physical representation of data in whole or in part, such as databases, photos, files, emails, financial exchanges, images, etc., or any part thereof. For example, some embodiments described herein may secure regulated and/or sensitive information (RSI) to ensure access to the information is restricted only to those authorized to access it. RSI may include any sensitive information, such as payment card information (PCI), electronic voting data, financial, SOX, HIPAA, or other regulatory or sensitive information, for example. RSI may be stored in one or more electronic files, and may only be part of a file in some cases. A holistic approach to security may be provided wherein access to RSI may be controlled by the data owner and limited to authorized devices and individuals. RSI activity may be monitored and logged. RSI may be protected even if transferred between physical and digital media and/or accessed or obtained by an unauthorized entity. For example, even if an unauthorized person obtains physical access to RSI, they may be unable to read, utilize, or exploit the RSI. The approach described herein may provide a complete ecosystem for protecting RSI. In some embodiments, the described approach may be phased in, incrementally enhancing security as components of the ecosystem are developed and rolled out.

The systems and methods described herein may provide some or all of the following security features: authentication (ability to specifically identify individuals and/or devices), authorization (ability to specify, restrict, and/or enforce access rights), nonrepudiation (any changes or access may be recorded such that the change or access cannot be denied after the fact), data confidentiality (assurance that protected information is only available to those authorized to access it), data integrity (assurance that data has not been changed without authorization), and/or data availability (assurance that the protected information is available for authorized use).

Systems and methods described herein may comprise one or more computers, which may also be referred to as processors. A computer may be any programmable machine or machines capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, or other wireless connections). Connections between computers may use any protocols, including connection-oriented protocols such as TCP or connectionless protocols such as UDP. Any connection through which at least two computers may exchange data can be the basis of a network. In some embodiments, the computers used in the described systems and methods may be special purpose computers configured specifically for document security. For example, a device may be equipped with specialized processors, memory, communication components, etc. that are configured to work together to evaluate and secure documents and/or perform other functions described herein.

### Quantum Security Modules and Normalized Security Scores

The systems and methods described herein may secure documents in one or more systems based on the Quantum Security Model (QSM). QSM is a security measurement and comparison methodology. QSM may provide a normalized methodology of breaking down a system and evaluating primitive components in a consistent manner, which may allow interdependencies to be more accurately understood and measured. QSM may provide a method to normalize the resultant evaluation of the primitive components to a quantifiable score. QSM may allow a resource owner to specify what evaluating (signing) authorities they recognize and accept. QSM methods may be used to evaluate both the current and probabilistic future security state of a system or device. QSM may allow individual resource owners to specify and verify an asset's security score prior to granting access. QSM may enable assets with computational ability to mutually authenticate each other prior to sharing resources or services. In the systems and methods described herein, QSM may be used to control access to individual files (“protected documents”) or collections of files.

In QSM, a common measurement may be reached through an evaluation process conducted on a device, system, or entity (the “asset”) where an agreed upon, reproducible, independently verifiable security level determination is desired. A quantum security unit symbolized as (“qS”) and pronounced (“qSec”) may be a standard unit of measure for security of a system based on the QSM. A qSec may be a temporal value similar to the position of a particle in quantum physics such that it may only be estimated at best and best known at the moment a measurement is conducted by an observer. After measurement, the position of a particle may only be probabilistically determined with a degrading precision over time. A qSec, being a quantum measurement, may share this characteristic. It may be postulated that systems may be viewed as wave-like systems from the perspective of security and the principles of quantum mechanics can be applied. The security of a system is a property of that system. The passage of time, along with the normal functioning and operation of the system and its environment may all affect the security of a system. As a result, the security of a system may be dynamic and the known state of the security may be transient by nature. Similar to the position of a particle, the security of a system may be quantifiably defined for a precise moment in time. The measurement results may provide a security measure represented in quantum security units, where a value of zero represents the complete lack of any security in a system, and increasing values indicate higher security.

The value that one qSec represents may be derived from criteria to be evaluated during the system security measurement process. Each criteria may have a common value range related to their impact to security. Also, each criteria may have an associated evaluation process that produces a result within that range. A criteria weighting method may be applied to each criteria, and the common value range may become a security value scale for what a quantum security measurement represents as denoted in qSecs. For example, the qSec value may represent an eigenvalue in matrix mechanics. Different observers at different periods of time may theoretically interpret this value differently depending on their perspective and may desire to apply their own probabilistic filters to a qSec value or conduct their own measurement process to determine the qSec value of a system. Thus, the value may be predetermined in order to utilize qSec measurement in a meaningful way when classifying system security. The predetermination may be done automatically, may be set by a user, and/or may be set at or before system initialization.

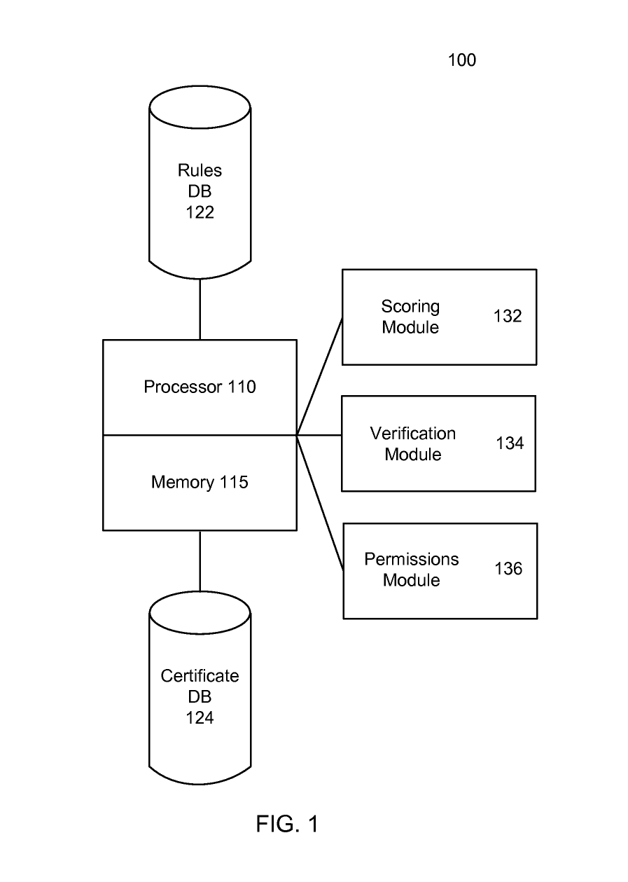

FIG. 1 is a security module 100 according to an embodiment of the invention. The security module 100 may include a processor 110 and physical memory 115, for example a rules database 122 and/or a certificate database 124. The rules database 122 may store various access control rules as described in greater detail below. The certificate database 124 may store various certificates for devices, documents, users, etc., as described in greater detail below. The security module 100 may also include sub-modules such as a scoring module 132 which may derive and/or update security scores, a verification module 134 which may determine whether security rules are met, and/or a permissions module 136 which may automatically or manually define security rules and/or access permissions. Note that any device described herein as performing security validations or as a QSM enabled device or QSM device may include a security module 100 and may use the security module 100 to perform the validations and/or other processes related to QSM as described.

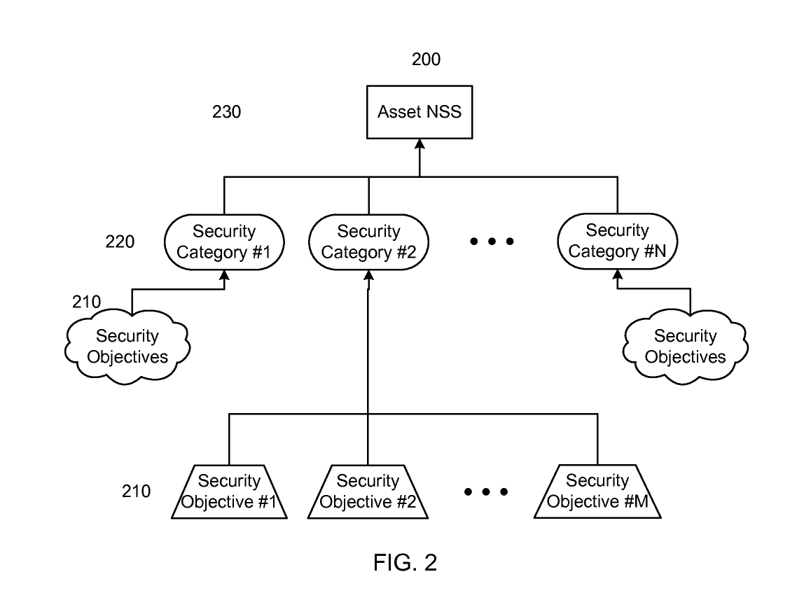

FIG. 2 is a security score derivation 200 according to an embodiment of the invention. An evaluation process may be conducted on an asset to determine its security level. To achieve this result, a normalized security score representing the security level of the asset may be generated at the conclusion of the evaluation. The score may be normalized through a process that applies a predetermined set of security criteria (“security objectives”) 210 against the asset's primary functions (what it does, its purpose) isolated by predefined grouping (“security category”) 220 for assessment purposes. For each security objective 210, an assessment may be conducted on each of the asset's security categories, and a security score may be generated (the “objective score”) that falls within a range assigned to the security objective. A degree of importance for each score may vary from asset to asset or even instance to instance. When all of the objective scores have been generated, they may be combined using a predefined objective score aggregation method (e.g., a weighted average), resulting in a normalized security score (“NSS”) 230.

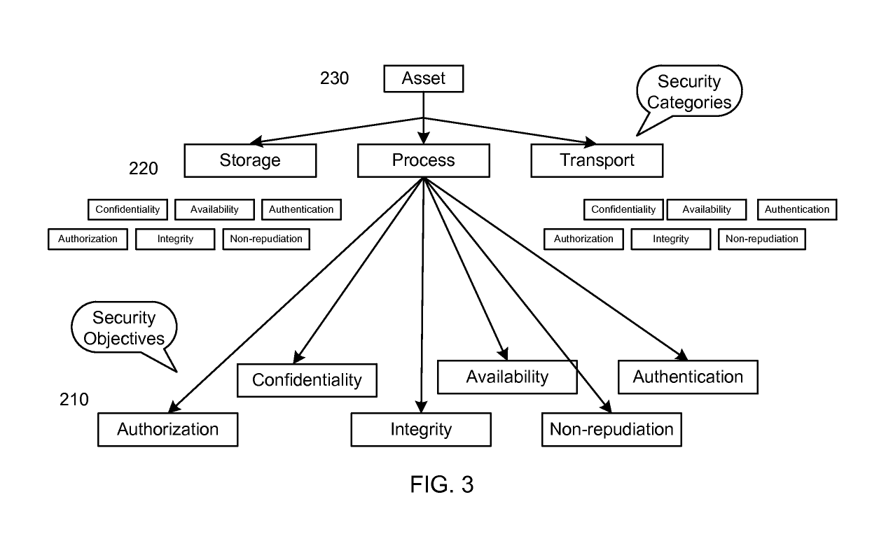

FIG. 3 is an asset 230 according to an embodiment of the invention, showing specific examples of security categories 220 and security objectives 210 that may be used in some embodiments. For example, an asset 230 may have storage, process, and transport security categories 220, which may correspond to primary functions performed by the asset 230 (e.g., data storage, data processing, and data transport). Each of the security categories 220 may have authorization (AZ), confidentiality (C), integrity (I), availability (AV), non-repudiation (NR), and authentication (AI) security objectives 210. An NSS for the asset 230 may provide an indication of how well the asset 230 meets the security objectives 210 overall, based on how well each of the functional categories associated with the security categories 220 score on the security objectives 210.

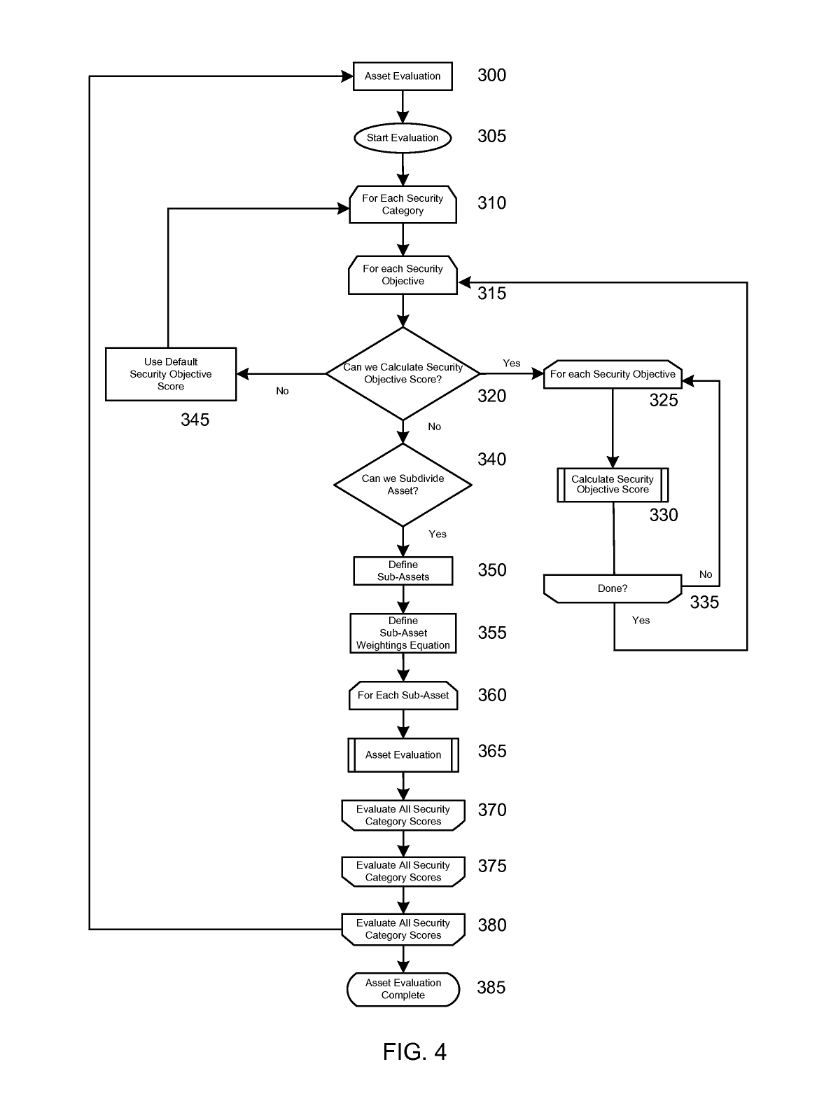

FIG. 4 is an asset evaluation 300 according to an embodiment of the invention. Some assets may be complex (e.g., made up of many subcomponents). For these complex assets, a measuring technique such as the technique 300 of FIG. 4 may be conducted on each subcomponent independently to derive an NSS value for each subcomponent. These subcomponent values may be combined to produce the highest order asset's NSS. An asset may be chosen for evaluation, and evaluation may begin 305. One or more security categories 220 may be identified, and each security category 220 may be evaluated 310. Each security category 220 may include one or more security objectives 210, and each security objective 210 may be evaluated 315. The security module 100 may determine whether a security objective score can be calculated 320 for the security objective 210. If so, the security objective score calculation may begin 325, and its security objective score may be generated 330. Examples of security objective score calculations are discussed in greater detail below. When the score has been calculated 335, the next security objective 210 may be selected 315. If a security objective score cannot be calculated 320 for the security objective 210, the security module 100 may determine whether the asset should be subdivided 340. Some assets may be too complex to derive the security objective scores directly, or may comprise components, devices, and/or systems that have been previously evaluated. To accommodate these situations, assets may be sub-divided.

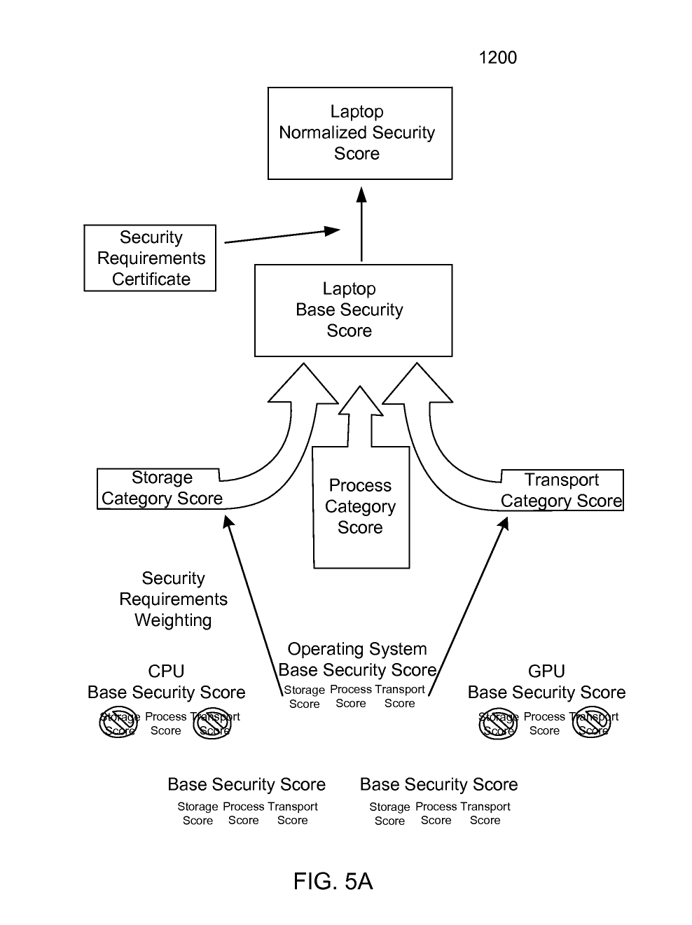

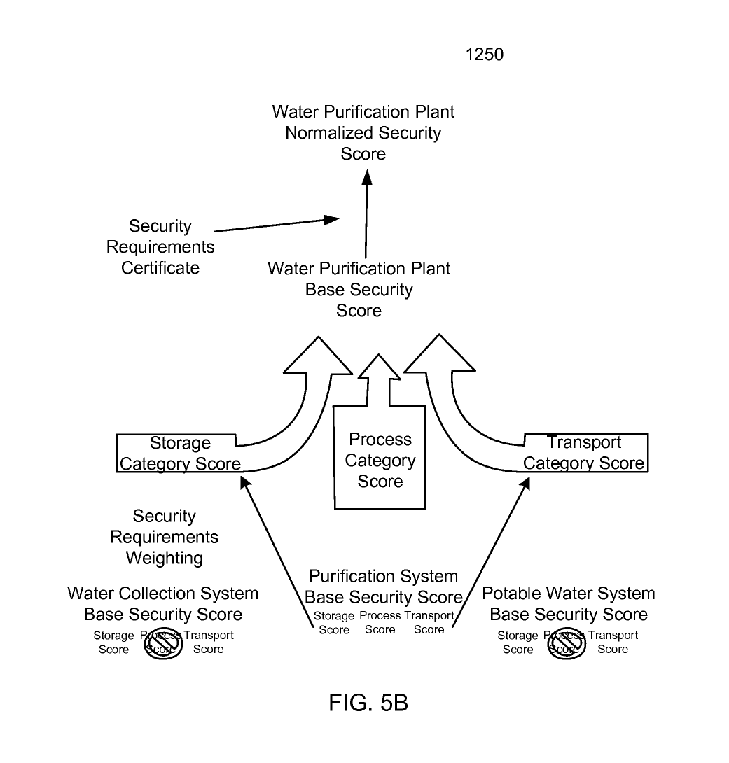

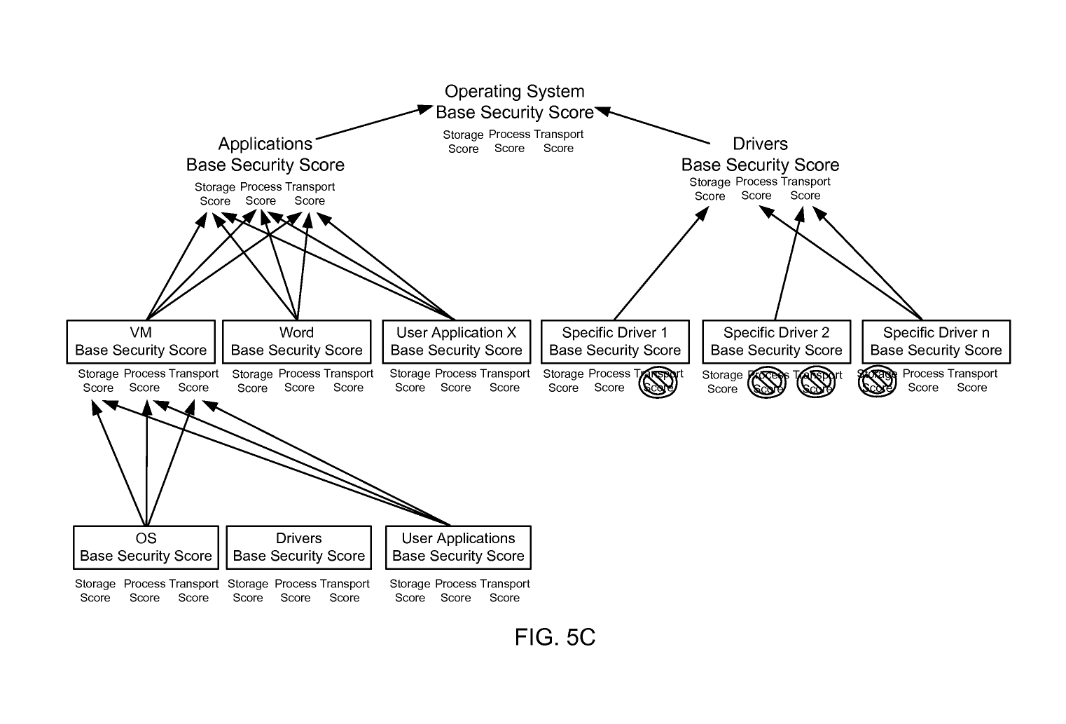

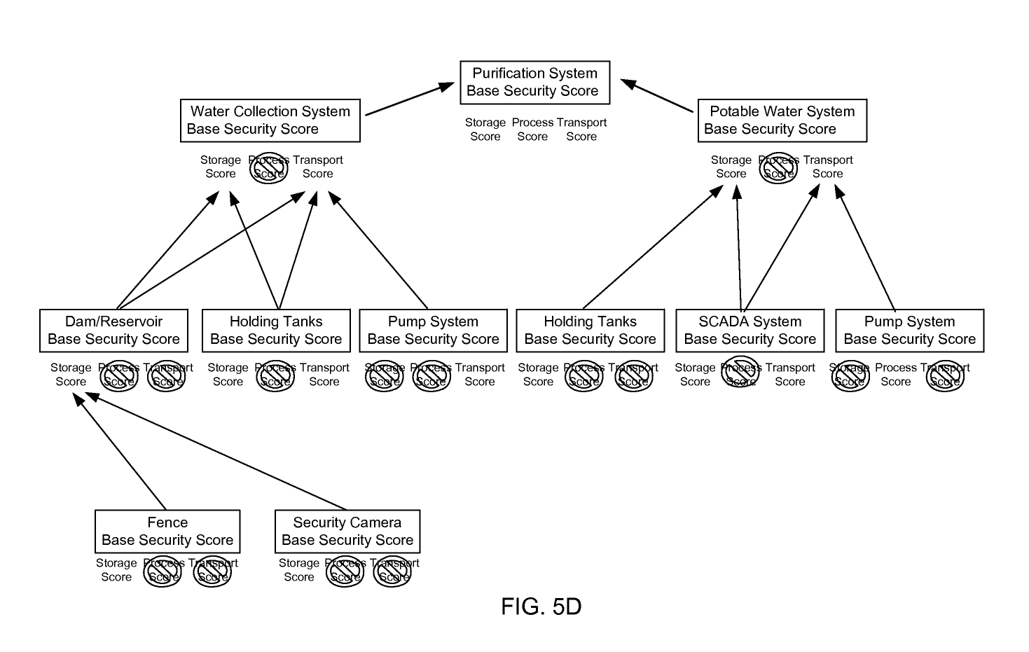

FIGS. 5A-5D are asset subdivision examples 1200 and 1250 according to embodiments of the invention. FIG. 5A depicts this principle using a laptop as an example, wherein the laptop is divided into CPU, operating system, and GPU components. FIG. 5B depicts a water purification plant as another example, wherein the plant is divided into water collection system, purification system, and potable water system components. As shown, it may be possible for some sub-assets to only contribute to a single security category score, while others may contribute to multiple security categories. FIG. 5C shows how the laptop sub-assets from FIG. 5A may be broken down further into specific drivers under the drivers sub-asset and specific applications under the application sub-asset. In the illustration, the Virtual Machine (VM) sub-asset of the applications sub-asset is further broken down to the applications running under the VM. This process may be repeated as necessary until every sub-asset may be accurately evaluated. FIG. 5D shows the further breakdown of the water purification sub-assets of the pre-purification sub-asset from FIG. 5B, demonstrating that QSM may be applicable to any critical infrastructure component or asset requiring evaluation regardless of the type of asset. A knowledgeable person in the area to which the asset belongs may follow this methodology and recursively break any complex system down to further sub-assets until the system consists of primitives (sub-assets to which an evaluation can or has been performed). In the water plant example these may be sub-assets like fences, guards, and locks whose impact on physical security may be well documented and may be quantified.

Referring back to FIG. 4, if no subdivision is possible, a default security objective score may be assigned 345, and the evaluation 300 may move on to the next security objective 315. If subdivision is to be done 340, the security module 100 may define sub-assets 350 and sub-asset weightings equations 355. As noted above, sub-assets may be further divided themselves, in which case analysis may be performed on the further divided sub-assets. For each sub-asset 360, an asset evaluation 365 may be performed, and a security objective score 370 may be generated. All security objective scores may be evaluated 375, and security category scores may be evaluated 380. If there are more security categories 220 to evaluate, the next security category 220 may be selected 310, and the evaluation described above may be performed for the security objectives 210 of the next security category 220. When all security categories 220 have been evaluated, the asset evaluation may end 385. For the asset 230 of FIG. 3, with three security categories 220 each having six security objectives 210, a total of eighteen evaluations may be performed.

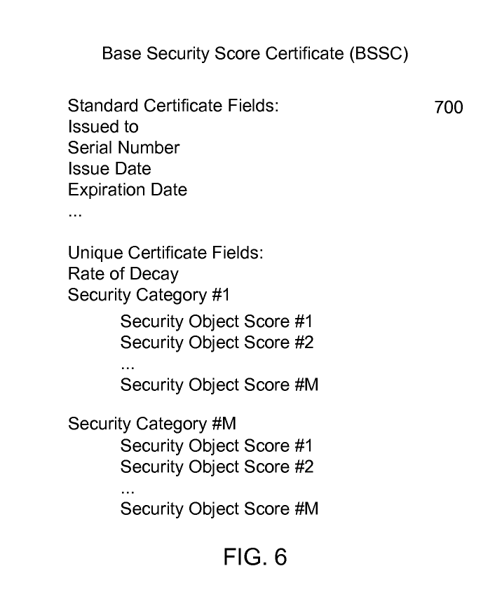

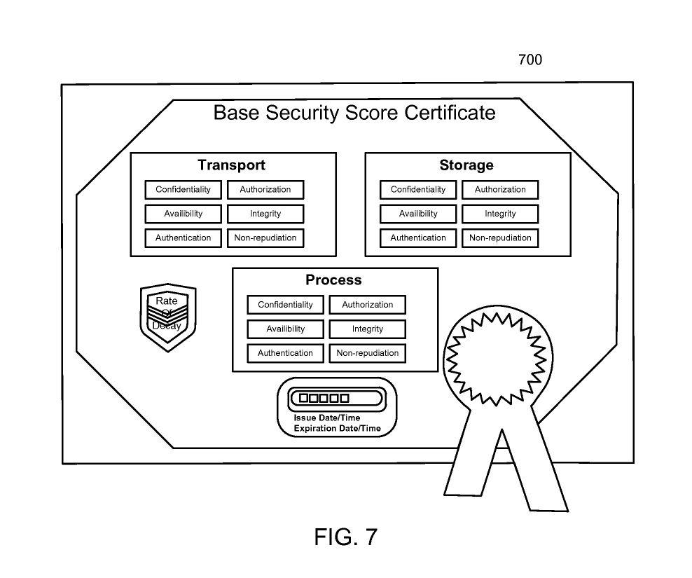

Utilizing NSS, objective score sets, and derived security rules along with cryptographic techniques such as public-private key certificates, digital assets may securely store their security level along with the time the evaluation of the asset was performed in a Base Security Score Certificate (BSSC). FIG. 6 is a BSSC 700 according to an embodiment of the invention. The BSSC 700 may include scores for each security objective 210 and category 220. For the example asset 230 of FIG. 3, the BSSC 700 may be a 3-tuple of security category 220 scores (SCS), each of which may in turn be a 6-tuple of security objective 210 scores. FIG. 7 is an example BSSC 700 for the asset 230 of FIG. 3. This example BSSC 700 may have a base security score (BSS) expressed as BSS=((Transport SCS), (Storage SCS), (Process SCS)) or BSS=((T_{C}, T_{I}, T_{AZ}, T_{AI}, T_{AV,} T_{NR}), (Sc, S_{I}, S_{AZ}, S_{AI}, S_{AV}, S_{NR}), (P_{C}, P_{I}, P_{AZ}, P_{AI}, P_{AV}, P_{NR})), where C=confidentiality, I=integrity, AZ=authorization, AI=authentication, AV=availability, and NR=non-repudiation. The BSSC 700 may be signed by an individual, corporation, regulatory agency, or government agency, for example. The BSSC 700 may include a date/time the certificate was issued and a date/time the certificate will expire. The BSSC 700 may also include a rate of decay for the NSS, which is described in greater detail below.

To take into account the transient nature of security, meaning security may have a high probability of degrading post measurement, a security rate of decay (ROD) algorithm may be used to factor in probabilistic security degradation that has occurred since the last NSS evaluation noted in the BSSC was conducted. The ROD may be used to determine a realistic security score for a system given the time that has passed since a BSSC was initially issued. The algorithm for calculating the ROD may be dependent upon the metrics chosen for scoring the system. By using the NSS and objective score sets as inputs along with the time of the last evaluation (and optionally other security rules or recorded asset usage history), a new NSS score may be calculated and used for more accurate common security comparisons.

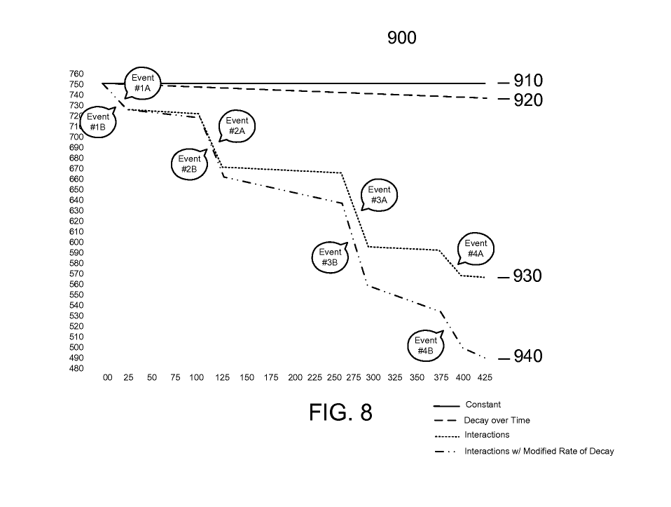

FIG. 8 is a security score degradation 900 according to an embodiment of the invention. Line 910 shows a security for a system without a ROD value which remains constant over time. However, the longer a system runs the more likely it may be for the system to become compromised. This decrease in security is shown by line 920, which shows a linear ROD of 0.01 per unit of time. Lines 930 and 940 show the security of a system over time while taking into account events, which may negatively impact the security of the system. Line 930 represents four security events which decrease the security of the system but do not cause a change in the ROD. Line 940 depicts the same four events but assumes each of these events also alters the ROD value. The events depicted in FIG. 8 may be the result of connecting a USB device to the system, connecting the system, to an untrusted network, browsing to a malicious website, or installing a downloaded application, for example.

In order to allow assets to maintain a history of significant events, the QSM may support the concept of certificate chains, or Security Score Chain (SSC). The BSSC may provide a base certificate in any SSC. The asset can modify the score and sign a new certificate with the BSSC, thereby creating the SSC. When creating an SSC, the asset may include a record of why the modification is being made. In FIG. 8, after each event on line 930 or 940, an update to the SSC may be made reflecting the change to the ROD and documenting the events that caused these changes. If the BSSC is given a ROD, the new security score may adjust for any decay (e.g., as shown in line 940) since the new certificate in the chain will have a new issue date/time. The expiration date/time may not be extended past the expiration of the BSSC, but may be shortened if appropriate. In addition, if appropriate, the ROD may be modified to reflect new risks and threats.

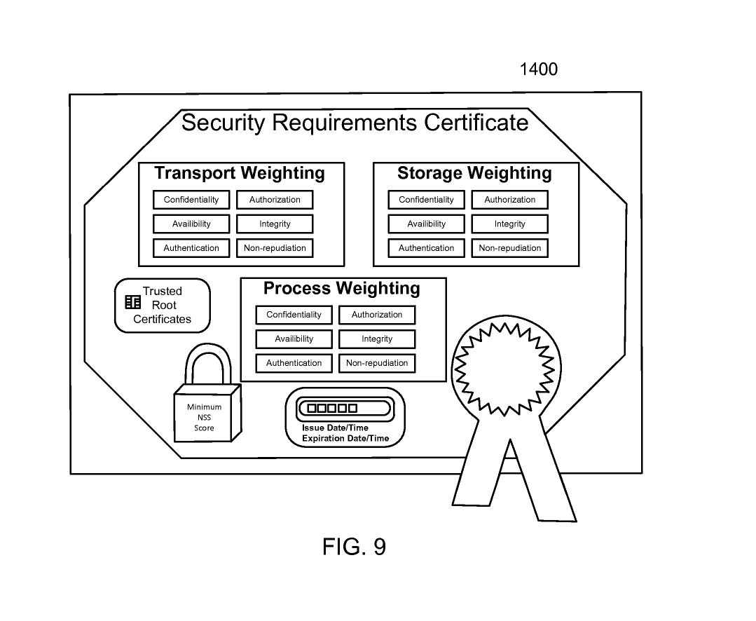

FIG. 9 is a security requirements certificate (SRC) 1400 according to an embodiment of the invention. The SRC, like a BSSC, may be a cryptographically secured, signed document containing security requirement weightings (SRW) for each of the security objective 210 scores (SOS), the security weightings for each of the security objectives 210, the authorized BSSC and SSC signatories, and/or a minimum Normalized Security Score (NSS). The NSS may be the highest-level score in the QSM and may be calculated by applying the security requirement weightings in the security requirements certificate to the security objective scores in the base security score. Mathematically, the SRW may be similar to the BSSC (e.g., a 3-tuple of Security Category Weightings (SCW) (which may be the percentage weighting each of the categories contribute to the NSS), with each SCW being a 6-tuple value of security objective weightings (SOW) (which is the percentage weighting attributed to each of the SOS values). For example, an SRW may can be represented as: SRW=(Transport SCW(Transport SOW), Storage SCW(Storage SOW), Process SCW(Process SOW)) or SRW=(SCW(T_{C}, T_{I}, T_{AZ}, T_{AI}, T_{AV}, T_{NR}), SCW (S_{C}, S_{I}, S_{AZ}, S_{AL}, S_{AV}, S_{NR}), SCW(P_{C}, P_{I}, P_{AZ}, P_{AI}, P_{AV}, P_{NR})), for the example of FIGS. 3 and 7.

The NSS may provide a metric that can be used to evaluate the security posture of a given asset over time (ΔT). This score may be used to authenticate the asset, authorize access, compare the security utility of assets, or determine where improvements should be made to a given asset, for example. A NSS may be calculated as follows: NSS=(BSS_{T}*SRW)−(ROD*ΔT). Thus, a NSS for the example of FIGS. 3 and 7 may be NSS=(SCW_{T}*(T_{C}*TW_{C}+T_{I}*TW_{I}+T_{AZ}*TW_{AZ}+T_{AI}*TW_{AI}+T_{AV}*TW_{AV}+T_{NR}*TW_{NR})+SCW_{S}*(S_{C}*SW_{C}+S_{I}*SW_{I}+S_{Z}*SW_{AZ}+S_{AI}*SW_{AI}+S_{AV}*SW_{AV}+S_{NR}*SW_{NR})+SCW_{P}*(P_{C}*PW_{C}+P_{I}*PW_{I}+P_{AZ}*PW_{AZ}+P_{AI}*PW_{AI}+P_{AV}*PW_{AV}+P_{NR}*PW_{NR}))−(ROD*(T_{CURRENT}−T_{ISSUED}))

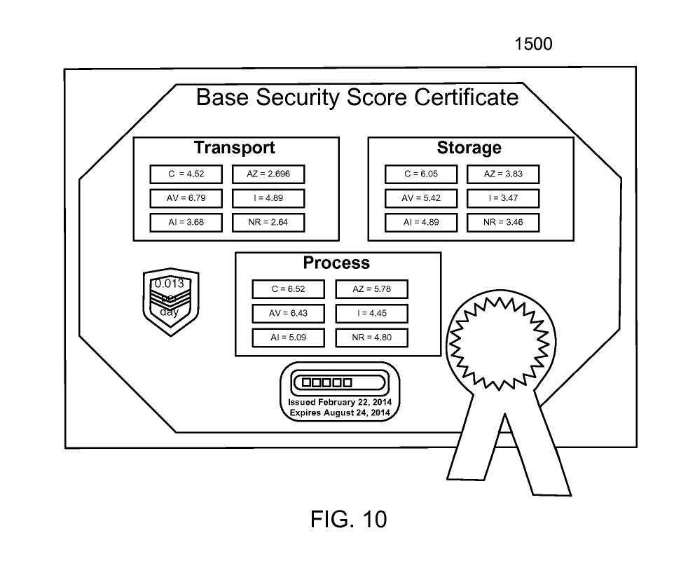

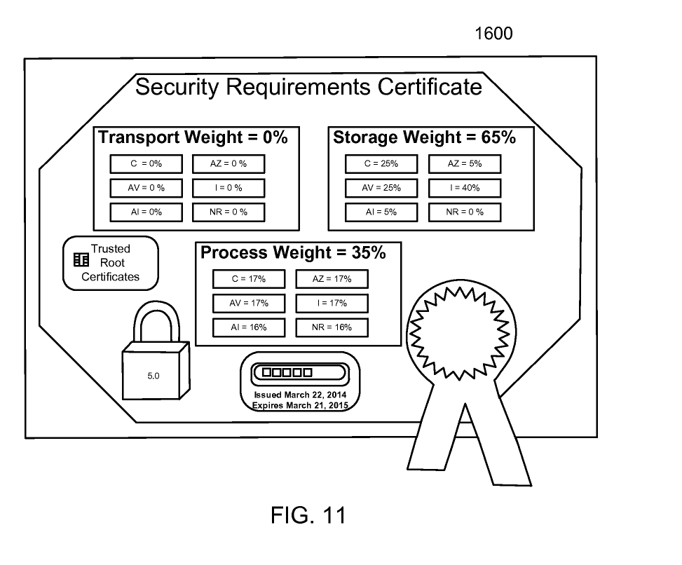

FIG. 10 is a base security score certificate 1500 according to an embodiment of the invention. In this example, BSS=((6.05, 3.47, 3.83, 4.89, 5.42, 3.46), (6.52, 4.45, 5.78, 5.09, 6.43, 4.80), (4.52, 4.89, 2.69, 3.68, 6.79, 2.64)). The ROD is 0.013/day, and the certificate was issued on 22 Feb. 2014 and has an expiration of 24 Aug. 2014. FIG. 11 is a security requirements certificate 1600 according to an embodiment of the invention. In this example, SRW=(0% (0%, 0%, 0%, 0%, 0%, 0%), 65% (25%, 40%,5%, 5%,25%, 0%), 35% (17%, 17%, 17%, 16%, 17%, 16%)). The 0.0 weighting in the transport security objective weighting shows that this particular asset owner does not care about or does not utilize transport activities. Such a scenario may exist for a stand-alone machine or a smartcard, which may not have any means of transporting data but does have storage and processing capabilities. The minimum required NSS listed in the SRC is 5.0 and the current date or TCURRENT=23 Mar. 2014. Below is the detailed calculation of the storage portion; the other detailed calculations are omitted:
Storage portion=0.65*(0.25*6.05+0.4*3.47+0.05*3.83+0.05*4.89+0.25*5.42+0.0*3.46)=3.05
NSS=(0+3.05+1.93)−(0.013*(23 Mar. 2014-22 Feb. 2014)=(4.98−(0.013*29))=4.6

This computed NSS may be compared against the stored min NSS value, if it is above the min NSS value, it may be approved. In the above example, since the calculated NSS of 4.6 is less than the SRC permits (5.0), the device would be rejected.

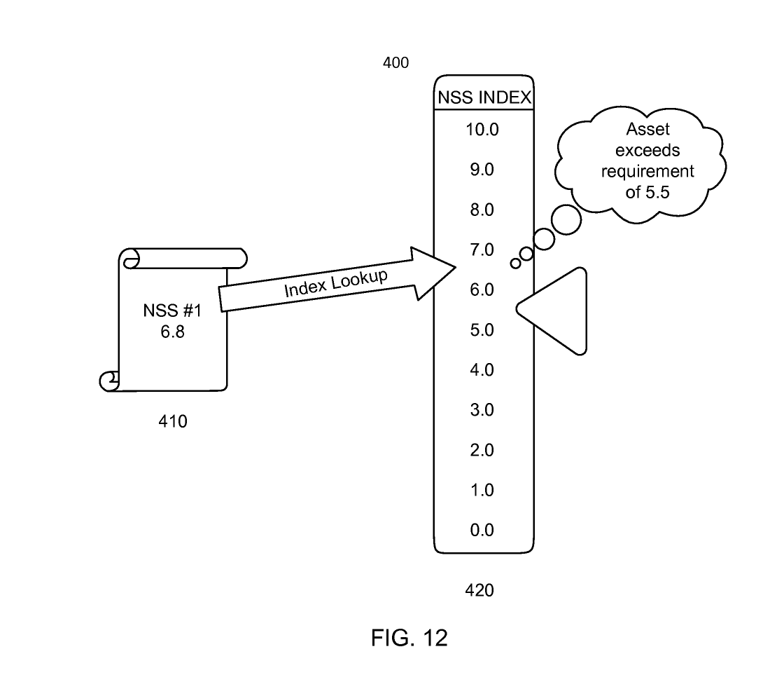

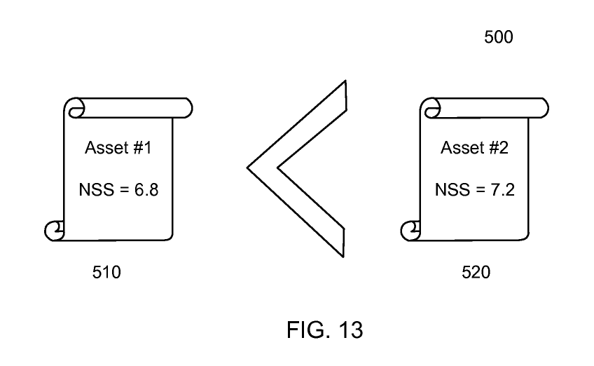

The NSS values may be compared and contrasted allowing a security level index to be applied to the security of an asset. FIG. 12 is an NSS comparison 400 according to an embodiment of the invention. An NSS value 410 may be compared to an NSS index 420 to determine whether the NSS for an asset indicates that the asset has a minimum required security level. For example, the NSS index 420 may indicate that an asset with a score of 5.5 or more has an acceptable security level, and an asset with a score less than 5.5. does not have an acceptable security level. In the example of FIG. 12, the asset has an NSS of 6.8 and thus exceeds the requirement of 5.5. Additionally, two or more assets may be compared to determine if they have the same or contrasting security levels, or to determine which of the assets are more secure. FIG. 13 is an NSS comparison 500 according to an embodiment of the invention. In this example, asset 1 has an NSS value 510 of 6.8, and asset 2 has an NSS value 520 of 7.2, so asset 2 may be regarded as more secure than asset 1. Based on agreed upon pre-determined security objectives and categories along with the pre-determined score aggregation processes and common security measure methods, transitivity may suggest that the security comparison is an agreed upon, reproducible, independently verifiable security comparison.

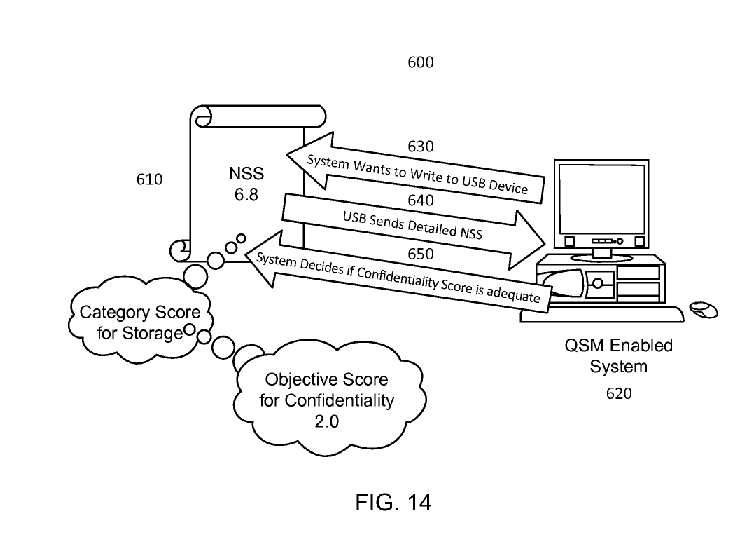

Utilizing the NSS and the objective score set, extended security comparisons may be conducted that may commonly measure more specific security attributes of an asset. FIG. 14 is a security verification 600 according to an embodiment of the invention. An asset 610 (e.g., a USB device) may have a calculated NSS (e.g., 6.8). a QSM enabled system 620 may verify asset security 600 before interacting with the asset. The system 620 may be asked to perform an operation using the asset (e.g., a write operation to the USB device) 630, for example via user input. The asset 610 may send its NSS 640 to the system 620. The system 620 may evaluate the NSS (e.g., by performing a comparison as shown in FIG. 12). If the NSS evaluation indicates adequate security, the operation may proceed. If not, the operation may be prevented.

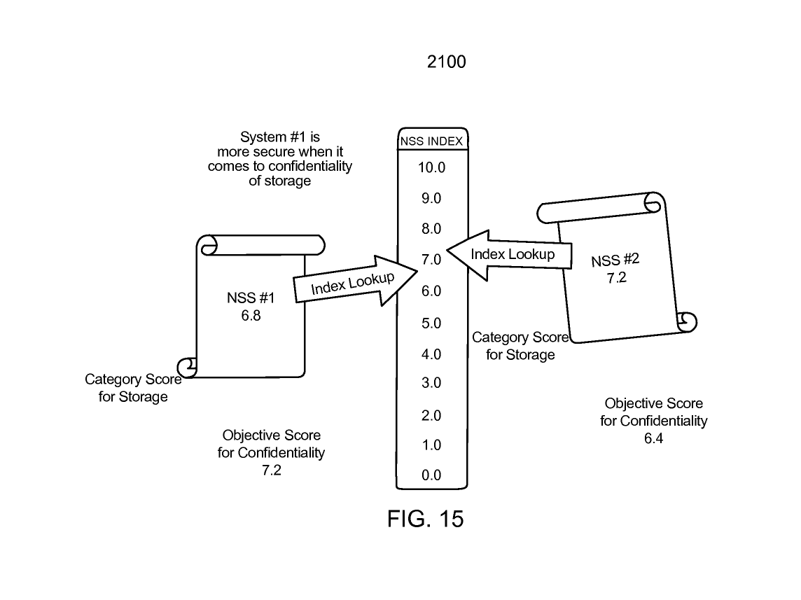

FIG. 15 is a security comparison 2100 according to an embodiment of the invention, wherein two different systems are being compared. System #1 has a lower NSS score than system #2, but system #1 has a higher category score for confidentiality of storage than system #2. Comparisons such as these may be used to determine which product to buy (e.g., which product best meets a user's security needs), or to determine which systems should be upgraded first, or to inform other decisions about system security.

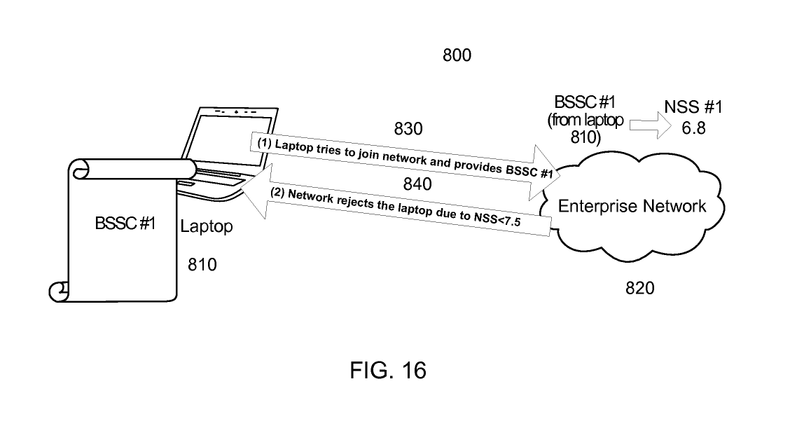

FIG. 16 is a security verification 800 according to an embodiment of the invention, wherein a BSSC of an asset (laptop 810) may be used for interaction with an enterprise network 820. The asset 810 may attempt to join the network 820 and may provide the BSSC 830. The network 820 may evaluate the BSSC and decide whether the asset 810 is secure 840. In this example, the asset 810 has an NSS in its BSSC that is below a threshold required by the network 820, so the network 820 denies access to the asset 810.

### Using QSM/NSS

The SOS may provide a probabilistic based evaluation determined by computing security metrics which may describe the probability of a compromise. This probabilistic equation may be expressed as SOS=P(Compromise|Security Measures≠Threats). The SOS is the probabilistic likelihood of a compromise of the asset due to the implemented security measures not safeguarding against threats, where threats are a probabilistic expression over time that an actor with a given motivation may utilize an exploit. Threats=P(Time|Actor|Motivation|Exploit). Time may be pulled out and carried in the BSSC, represented as the ROD, to allow the SOS to be a set of values. The ROD may indicate how sensitive the SOS is to time exposure. A higher ROD may indicate that the threat against the asset increases more over time than a ROD that is lower.

For example, a NSS may have a range of 0 to 10, with zero being no security and 10 being completely secure. If a given asset has a shelf life (or time until a patch or update is required) of 770 days and no other factors contribute to reducing or extending this shelf life, one way of calculating the ROD may be by taking the maximum NSS value of 10 and dividing it by 770 days. ROD=10 (Max NSS value)/(days until 100% likelihood of compromise)=10/ 770=0.013/day. By reducing the calculated NSS by the ROD times the change in time (days), regardless of the security of the system, at the end of the 770 days the score would be zero. In other words, the system may be regarded as unsecure without some action. In practice, there may be some minimal value somewhere above zero at which the system may be considered unsecure, and this value may be represented as the minimum NSS in the SRC.

Another example may involve an ammo bunker at a military installation. The vault door on the bunker may contribute to one component (“S_{I}”) of security. Let the vault be rated at a 6 hour penetration level and let the vendor testing indicate a 60% penetration rate for a skilled attacker with unrestricted access after the 6 hour time period increasing by 5% every hour thereafter. Thus, S_{I} is 0.95 with a ROD step at 6 hours to 0.6 and a steady 0.05 decay per hour after that. With this clearly spelled out in the vault's BSS, the commander may order a guard to roam past the bunker every 3 hours (essentially resetting the ROD for the door). These two factors together may contribute a S_{I} for the door of a consistent 0.95.

The SRC may specify which signatories are recognized and accepted by a resource when evaluating the BSSC of an asset looking to gain access to the resource. This may protect the resource against an attempt to falsify security scores by generating a BSSC signed by an unauthorized signatory. In addition, the ability to specify trusted signatories may allow for variation in the security metrics used and the evaluation scale for NSS. For example, security metrics may be based on the Sandia RAM series evaluations and the specification of such may allow a conversion from the Sandia RAM series evaluations to the NSS in a range from 0-100. Likewise, another embodiment may use the CARVER methodology or some pair-wise comparison evaluation and may use a QSM 0-10 scale. Similarly, an embodiment can utilize proprietary metrics and a scale of 0.00 to 1.00. Any and all of the above combinations may be utilized in the evaluation of a complex system, the NSS and QSM methodology may allow for their inclusion. QSM may take known shortcomings in methodologies into account by increasing the rate of decay and reducing the NSS due to the uncertainty of the metrics. Thus, existing systems and evaluations may be leveraged in the short term until a valid QSM evaluation may be performed.

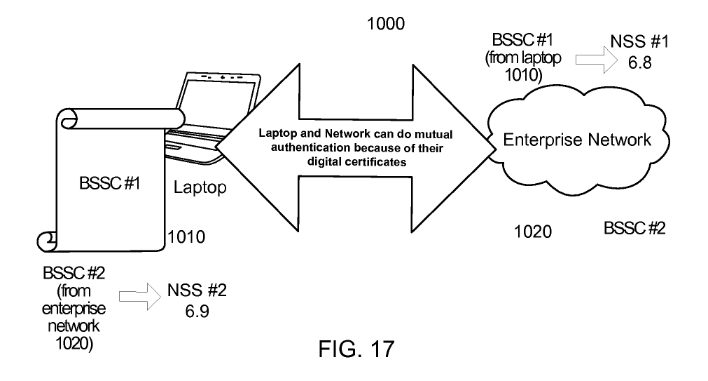

Enhanced authentication and authorization processes between assets may take advantage of the common security measuring and comparison methods described above. This may be done by forcing a real-time evaluation to derive the NSS and objective score set of an asset or utilizing the information stored in BSSC from a past evaluation as well as optionally using the rate-of-decay algorithm of an asset. Additional security rules such as the ones stored in BSSC may also be used as authentication or authorization security criteria. The security level validation may be conducted one-way for one of the assets engaged in the authentication or authorization process, as shown in the example security verifications described above. In some embodiments two-way validation (or all-way validation when two or more assets are trying to authenticate or authorize each other) may be performed, wherein each asset validates the security level of the other. FIG. 17 is a mutual security verification 1000 according to an embodiment of the invention. In this example, the laptop 1010 may validate the BSSC of the enterprise network 1020, and the enterprise network 1020 may validate the BSSC of the laptop 1010, and each asset may separately decide whether the other has a high enough security to permit interaction.

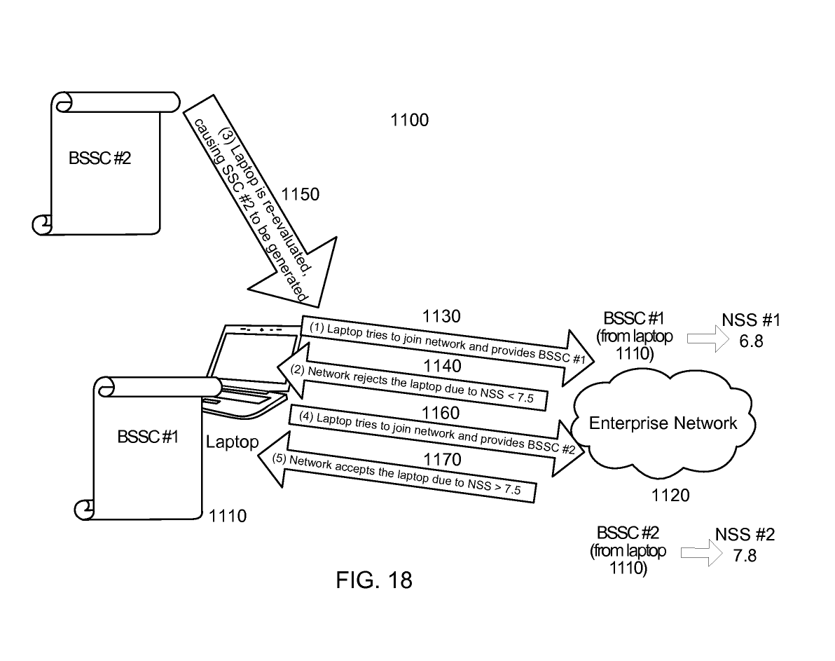

In some embodiments, a security rule enforcement during the verification process may prompt a reevaluation of one or more of the assets participating in an authentication or authorization. FIG. 18 is a security verification 1100 according to an embodiment of the invention. A BSSC of an asset (laptop 1110) may be used for interaction with an enterprise network 1120. The asset 1110 may attempt to join the network 1120 and may provide its BSSC 1130. The network 1120 may evaluate the BSSC and decide that the asset 1110 is not secure 1140. In this example, the asset 1110 has an NSS in its BSSC that is below a threshold required by the network 1120, so the network 1120 denies access to the asset 1110. The asset 1110 may be reevaluated by the security module 100 in response 1150. As noted above, NSS values may degrade over time. Furthermore, new security features may be implemented on an asset over time. Thus, the reevaluation 1150 may generate a new NSS value for the updated BSSC. In this example, the new value indicates that the asset 1110 is secure enough to interact with the network 1120. The asset 1110 may make a second attempt to join the network 1120 and may provide its updated BSSC 1160. The network 1120 may evaluate the BSSC and decide that the asset 1110 is secure 1170.

QSM evaluation of devices with built-in processing power, such as servers, PCs, and routers may be performed automatically. This may be accomplished by running a QSM process that utilizes a combination of backend databases, scans of configuration information on the computer, and/or automated penetration-testing tools to generate a NSS. This may allow a service provider or network to require at least a minimal security posture for devices that wish to connect to their services that may not have undergone a full QSM evaluation.

This automation may be taken a step further to pre-emptively protect QSM devices. If a new exploit or other threat is identified, a backend database may search for registered devices that are susceptible and take preemptive action. This action may be to lower their NSS, revoke their cert, and/or advise the asset owner that they should disable a particular service or install a patch or update or advise the system administrator of the threat, for example. Due to the nature of many computer networks, these preemptive services may require periodic communication between the devices and the backend services in some embodiments.

Automated evaluation and certificate generation may also allow for real-time evaluations to be performed for access to systems that may have a particularly high security requirement where a certificate that is even a few days old may not be acceptable, for example. These high security systems may require a certificate that is current (e.g., that day, that week, etc.). This may be handled automatically in some embodiments. An automated QSM evaluation process may allow systems to require reevaluation and recertification at every request to utilize system resources in some embodiments.

The following additional examples illustrate scenarios wherein the QSM may be used for authentication and/or authorization. For the purposes of this section, it may be assumed that devices within the QSM have an SSC. Devices or systems that have their own computing resources may also be assumed to have an SRC. An example of a device which may not have an SRC is a USB memory stick. Since many USB memory sticks do not have their own computing resources, they may be unable to compare their SRC to an SSC they receive, so there may be no reason for them to have an SRC. In addition, the SSC for a device without its own computing resource may simply be the BSSC since the device cannot update the SSC from the BSSC.

Devices using QSM may leverage the SSC in order to perform device authentication and authorize network access. This authentication and authorization may be mutual, allowing for each entity to authenticate and authorize the other, as described above. Utilizing an automated QSM evaluation tool, this mutual authentication may be expanded to external devices that may require temporary or occasional access to network resources, such as joining a Wi-Fi access point at a corporate office, accessing an online merchant, etc. A resource owner may not be able to require a physical assessment of every device that may require occasional access to their resources, where requiring the download or access of a QSM evaluation tool as part of the registration or signup process may be feasible. The QSM tool may then generate an automated BSSC based on an automated scan as discussed above, and then the device may participate in a mutual authentication exchange prior to being granted access to network resources.

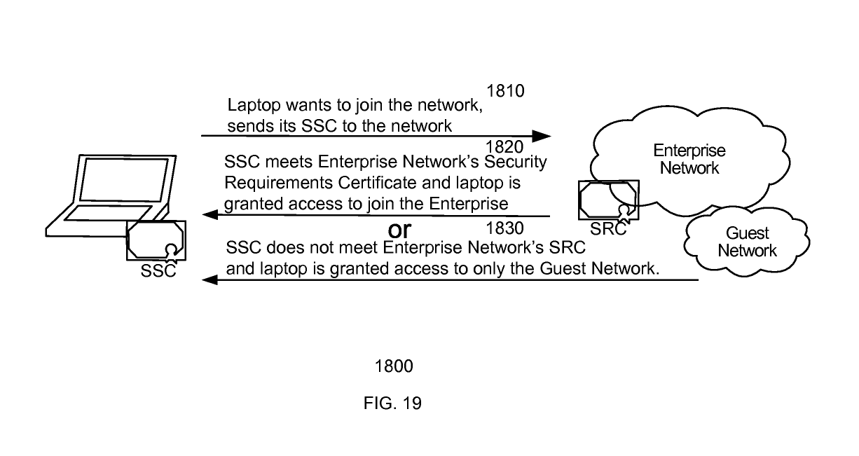

FIG. 19 is a security verification 1800 according to an embodiment of the invention. Upon connecting to a network, a device can provide the network with its SSC 1810 (or BSSC in some embodiments). Since the SSC is a cryptographically signed certificate, the SSC may be unique to the device. As a result, it may be leveraged for authenticating the device (rather than a user) to the network. The network can leverage the SSC for logging purposes to identify any device that may be behaving in a malicious or suspicious manner. A network administrator can leverage the SSC to decide whether or not the device is permitted to join the network based on the device's current security level in some embodiments. Devices meeting the requirements may be allowed to join the network 1820. Besides simply granting or not granting access, the SSC may be leveraged to determine which network segments the device is authorized to access. For example, a device failing to meet an enterprise's security requirements may be placed on a guest network, allowing the device to access the Internet while preventing access to enterprise resources 1830.

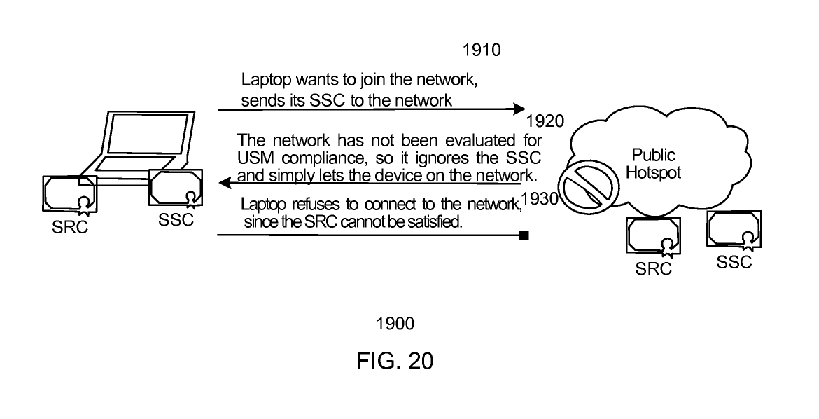

FIG. 20 is a security verification 1900 according to an embodiment of the invention. Devices can also leverage the SSC (or BSSC in some embodiments) in order to authenticate and authorize the network itself Since networks themselves may have cryptographically signed SSCs, the device may be able to identify the network it is attempting to join. This methodology could eliminate the possibility of network spoofing, whether wired, wireless, or cellular. Users and/or system administrators can leverage the SSC in order to limit which networks the device will use. For instance, an enterprise administrator could configure laptops so they can only connect to the enterprise network, a designated telecommuting router at the employee's house, and a designated cellular network. Employees may be unable to connect their device to any other network. In this example, the laptop may send its SSC to a network 1910. The network may ignore the SSC if it is not evaluated for NSS compliance 1920. In this case, the laptop may refuse to connect to the network, because the SRC is not satisfied 1930.

Furthermore, since the SSC may be updated occasionally, system administrators may permit devices to join less secure networks. The device's SSC may be updated to indicate which insecure network it had joined. Due to the resulting decrease in the SSC, the enterprise network may force the device to be re-evaluated before allowing it to re-join the network. For example, such techniques may be useful when employees travel with their laptops. In addition, users or system administrators may leverage the SSC of the network to authorize which device resources a network may be allowed to access. For example, the device's firewall may prevent networks not meeting certain security levels from being permitted to access file shares or web servers running on the device.

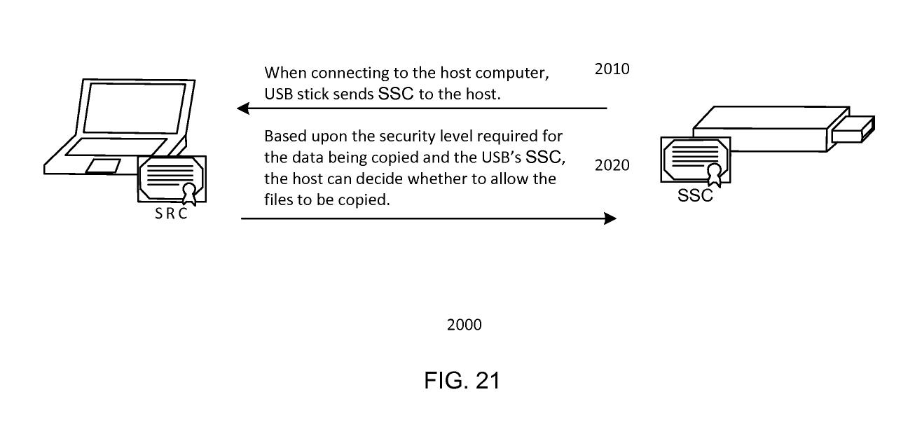

FIG. 21 is a security verification 2000 according to an embodiment of the invention. Besides authenticating and authorizing networks, a computer may authenticate and authorize devices based upon their SSC (or BSSC in some embodiments). For example, a USB storage device may contain an SSC and send the SSC to the computer when connecting to the computer 2010. If the SSC does not meet certain criteria (e.g. does not adequately encrypt data at rest), the host computer may prevent a user from copying information to the USB stick 2020. Furthermore, if the host computer can detect the nature of the data being copied, the decision 2020 on whether or not to allow the copy to occur may be based on a combination of the data itself and the SSC of the destination device. Similar examples could exist for many other types of devices. In some embodiments, the handshaking between devices may be modified in order to ensure the SSCs are always transmitted. For example, as part of the USB handshaking protocol, both the host and slave devices may share their SSC. This may allow the devices to perform mutual authentication and authorization.

Devices may also utilize the SSC for allowing access to sensitive information on the device itself For example, a device with a trusted computing space may be configured to only grant access to encrypted information on the device if the SSC meets certain criteria. The trusted computing processor may detect an attempt to access an encrypted volume and then determine whether the current SSC meets the criteria for that encrypted volume. Even if the user knows the decryption keys, the device may prevent them from decrypting the information because the device (which may have been compromised) is no longer trusted. This may enable specially designed computing devices that leverage separate components for sensitive storage, which may require an SSC to comply with a SRC. Essentially, the sensitive storage component may be seen by the system as a separate device.

Hardware and software products may utilize a user provided SRC and desired SSC (within an available range) to automatically configure parameters and settings to establish SOSs to ensure compliance. Removing the burden from the user to determine what combination of parameters available in the product configuration may provide functionality and security. Likewise, resource owners may require certain services or devices to be disabled or stopped while accessing their resources. Leveraging both the auto configuration and QSM auto evaluation processes may allow for this type of dynamic configuration to match security requirements.

SSC may provide product purchasing information. A product manufacturer may provide the SSC for a product online, allowing for consumers to perform a direct comparison between products in their particular security environment. Similarly, web sites could allow potential consumers to submit an SRC in order to learn what products meet their security requirements. This may allow consumers to judge which product produces the desired security enhancement or performance prior to making the purchase. It may even be possible to develop systems to run simulations of systems in order to learn how implementing new products or configurations may impact overall security. Manufacturers may be able to quantify the amount of security they can provide to a user, and show how much security they will add over their competitors for a given security SRC.

### QSM Document Control

Protected documents may be encrypted using a public/private key pair for an authorized recipient or a group of recipients. The private key may be created and stored on a specially designated QSM authorizer. The authorizer may be, for example, a security module 100 whose permissions module 136 and/or other elements are configured to process the enhanced SRC 2200 and associated document control methods described below. The public/private key pair may be stored in a database along with a Globally Unique ID (GUID). Protected documents may be configured in the form of a compressed archive containing the file(s) to be protected along with an SRC, for example. A set of permission key-value pairs may be used to define permissions for each GUID. In addition, the SRC may specify which applications are allowed to act on the protected file, for example by validating the BSSC of the application and the BSSC of the host device.

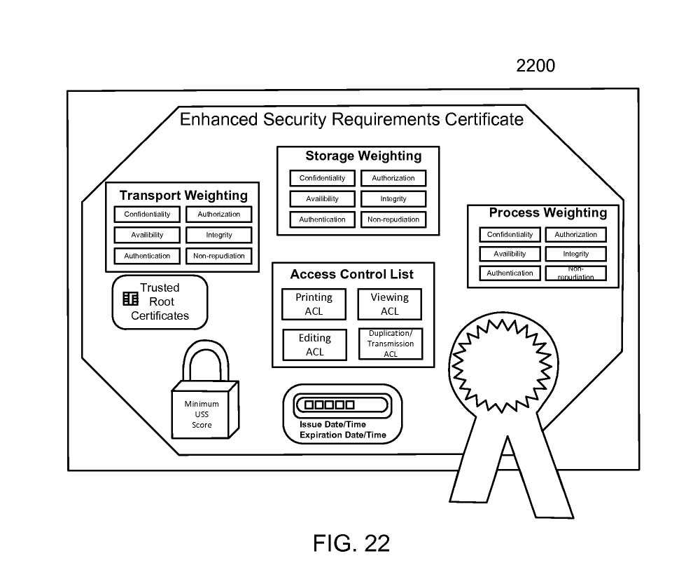

FIG. 22 is an enhanced SRC 2200 according to an embodiment of the invention. The enhanced SRC 2200 may be similar to other SRCs described above, but with the addition of one or more access control lists (ACLs). An ACL may define the applications with permissions to perform tasks on the file. For example, the SRC 2200 of FIG. 22 includes a printing ACL which may include a list of applications allowed to print the file, a viewing ACL which may include a list of applications allowed to view the file, an editing ACL which may include a list of applications allowed to edit the file, and a duplication/transmission ACL which may include a list of applications allowed to copy and/or send the file. The example ACLs of SRC 2200 should not be considered the complete list of possible types of ACL which could be implemented. The authorizer may be responsible for ensuring that both the requestor and the machine or application attempting to access the data is authorized according to the ACLs and meets the minimum security requirements according to the BSSCs.

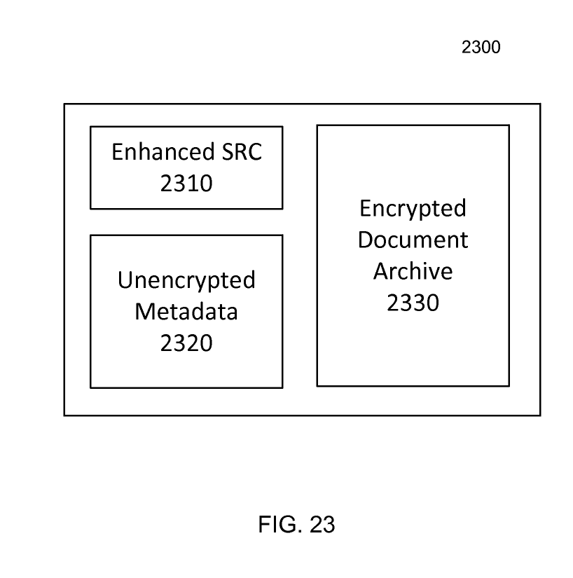

FIG. 23 is a protected document 2300 according to an embodiment of the invention. The encrypted document 2300 may include an enhanced SRC 2310, unencrypted metadata 2320, and an encrypted document archive 2330 which may contain the data being protected. While an unauthorized individual may see that a document exists and may be able to view the unencrypted portions, any protected content within the encrypted document archive 2330 may remain secure. Protected documents 2300 may be digitally signed, cryptographically guaranteeing the authenticity and author of a document 2300. In addition, changes to the document may be similarly digitally signed.

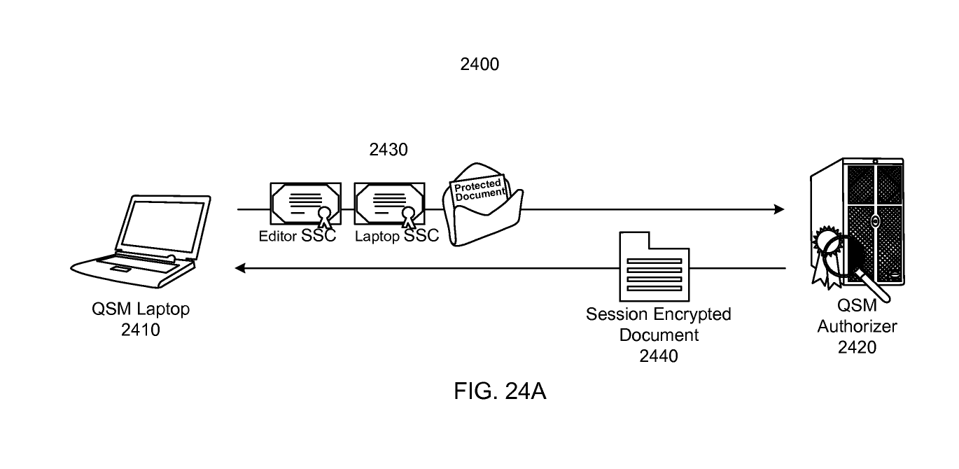

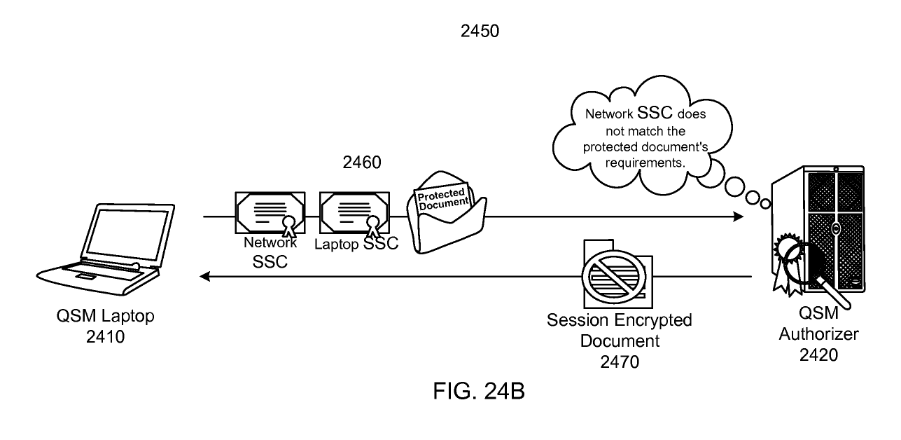

FIGS. 24A-24B are security verifications 2400 and 2450 according to an embodiment of the invention. QSM Document Control may provide additional levels of security for viewing, printing, or editing documents. For example, viewing of documents may be limited to specific QSM enabled applications or based upon the QSM value of the host computer as defined by the ACL and SSC (or BSSC in some embodiments), respectively. Requiring a QSM enabled application on a trusted host computer may provide enhanced protection, since the QSM application may enforce QSM document protections. For instance, the security settings may only allow other users to view the document, without providing the ability to print or edit it. Specialized viewer applications may also be leveraged to make it significantly more difficult for a user to copy the file, since the only version a user may see permanently stored on their computer is the encrypted protected document. It may be possible to restrict the document based on external factors, such as limiting viewings of a given document to a certain number of times, based on where the viewing computer is geographically or physically located, or based on which network a viewer is on when viewing the document, for example. For instance, viewing a document may be restricted to an enterprise computer while on the enterprise network.

With QSM, the system requirements for displaying protected documents may be as broad as QSM score or as narrow as users, systems, QSM score, and physical location, for example. When setting authorized viewer and system permissions, the use of a QSM application for display may be required. Permissions for viewing may be granted by a document owner on a user, viewing system, or combination basis, for example. Document owners may say which users are permitted to view a document and on which system. When a user wants to view a protected QSM document, the entire protected document (encrypted version along with SRC) may be sent to the QSM authorizer along with information about the user who requested the view. The protected document may be encrypted with a key only known to the QSM authorizer, forcing the viewer to leverage the authorizer in order to decrypt the message. This may prevent a compromised viewer system or a system whose QSM score has dropped below the required level from being able to bypass security measures for the document.

In the verification 2400 of FIG. 24A, a QSM enabled laptop 2410 may attempt to access a protected document. The SRC for the laptop 2410 itself, the SRC for the program attempting to access the document, and an identity of the laptop 2410 and/or laptop user may be sent along with the document to a QSM authorizer 2420 for verification 2430. The QSM authorizer 2420 may examine the document requirements and certificates and determine that the security levels of the laptop 2410 and software are high enough. The QSM authorizer 2420 may also check the laptop 2410 and/or user of the laptop 2410 against the ACL to determine whether the laptop 2410 and/or user are permitted to access the protected document. If the security levels are high enough and the laptop 2410 and/or user are on the ACL, access to the document may be provided 2440. In the verification 2450 of FIG. 24B, the QSM enabled laptop 2410 may attempt to access a protected document. The SRC for the laptop 2410 itself, the SRC for the program attempting to access the document, and the identity of the laptop 2410 and/or laptop user may be sent along with the document to the QSM authorizer 2420 for verification 2460. The QSM authorizer 2420 may examine the document requirements, certificates, and identities and determine that one or more of the SRCs does not meet the requirements for access and/or the laptop 2410 and/or user does not have access permission. Thus, access to the document may be denied 2470.

In many situations, similar information may be disseminated to multiple audiences, often with differing degrees of “need-to-know”. QSM documents may be leveraged to secure documents at a content or paragraph level rather than simply at a document level. Content markings (e.g., paragraph classifications) may automatically encrypt information based upon the author's markings Users attempting to view or print documents may only see segments of the document that they are authorized to access. This “redaction” may occur either transparently (i.e., making unauthorized segments completely vanish) or non-transparently (i.e., black-out text). Security verification as described above may be performed, and a document may be encrypted as required by the viewer's security level before the document is presented to the viewer.

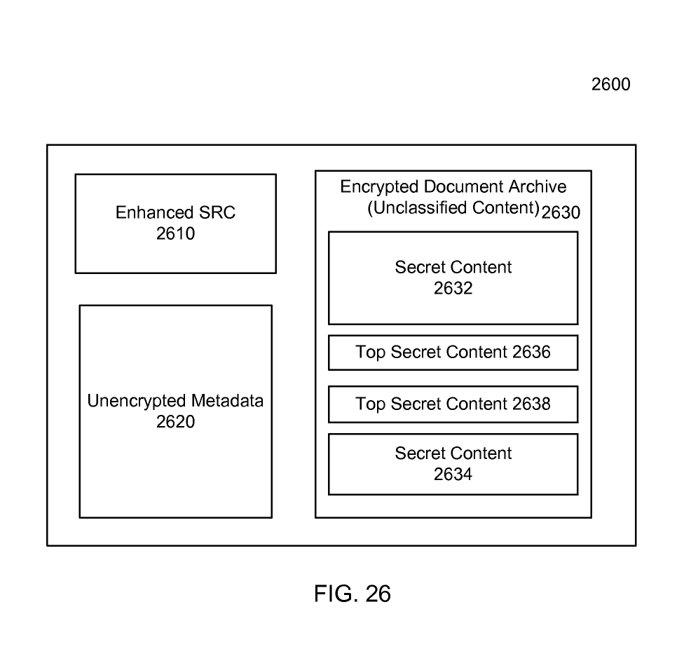

For example, FIG. 26 is a protected document 2600 according to an embodiment of the invention. A document 2600 may include multiple levels of information including unclassified information 2630, secret information 2632, 2634, and top secret information 2636, 2638 under protection. Even the lowest level of unclassified information 2630 may be protected. Users who are authorized to the secret level may only be able to see the content in the unclassified 2630 and secret 2632, 2634 levels. Users who are authorized to the top secret level may be able to see all protected content, including the top secret content 2636, 2638. Individual content sections may each have their own security requirements or may be classified under security levels, as shown. Additionally, content access may be further restricted based on the ACL. The ACL may be used along with the security requirements to define device and/or user permissions for the protected information. Thus, in one example, a user may have printing and viewing permission for some top secret content 2636, but only viewing permission for other top secret content 2638, as defined in the ACL.

Additionally, document access may be restricted based on a number of times a given document is allowed be viewed, where the viewing computer is geographically located, which network a viewer is on when viewing the document, etc. For example, viewing a document may be restricted to an enterprise computer while on the enterprise network.

Editing of protected documents may be similar in nature to viewing a document. In some embodiments, in order to ensure QSM protections are maintained, a specialized editor may be required. Document controls metadata may restrict users to only being able to edit particular regions or pages. When leveraging QSM document control for editing, versioning may also be controlled. In order to allow for file size optimization, users may be able to control how many versions of the document to maintain. Versioning could be set to −1 (no versioning), 0 (unlimited versions), n (number of versions to maintain besides the current version), for example.

QSM may also control document printing and/or reproduction. When setting printing permissions, the use of QSM applications for viewing and editing may be required in some embodiments. Permissions for printing may be granted by a document owner on a user, printer, or combination basis, for example. Owners may say which users are permitted to print the document. Owners may also say which printers (or set of printers) are allowed to print the document. QSM score and/or QSM certificates may be used to determine authorization. In addition, certain users may be permitted to print only on certain printers.

Enterprises and organizations may establish information classifications using a Security Level Definitions Certificate (SLDC). The SLDC may contain the security requirements for each classification along with a label for each classification. The SLDC may be loaded into QSM-enabled applications and devices which generate QSM protected documents. In addition, the SLDC may dictate whether the documents should be protected in their entirety or partitions. For example, users may be able to manually select the classification of the document (or portions of the document) and the application may automatically apply the required security measures. Furthermore, the applications and devices themselves may automatically recognize sensitive information and then either automatically protect the information or prompt the user to verify the classification. The SLDC may be able to ensure minimum security is in place for a document and may be modified by users to increase the security (e.g., by classifying some portions of a document as higher security). Security levels may be pre-defined and/or may be customizable by users. When applications and devices apply the SLDC settings to a protected document, they may use the actual requirements, rather than relying upon the user-friendly labels. This may allow the document to be opened (or restricted) on various platforms which may apply labels in different ways.

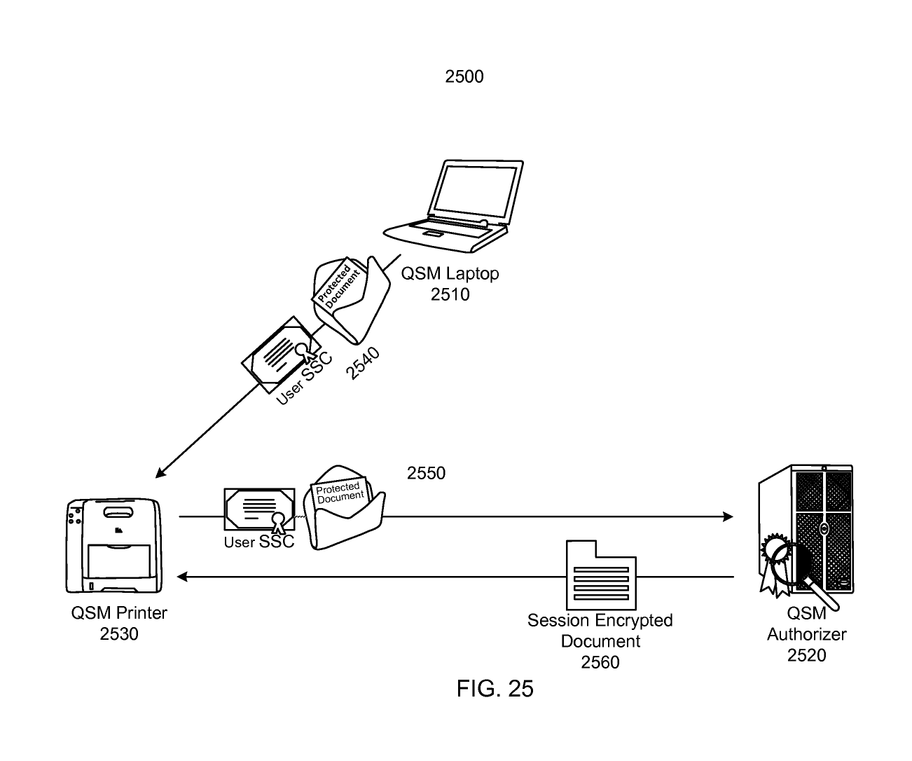

FIG. 25 is a security verification 2500 according to an embodiment of the invention. When a user wants to print a protected QSM document, the entire protected document (encrypted version along with SRC) may be sent to the printer along with information regarding the user who requested the printed copy and/or the computer of the user. The protected document may be encrypted with a key only known to the QSM authorizer, forcing the printer to leverage the authorizer in order to decrypt the message. After the authorizer has confirmed that the device is allowed to print the document, the authorizer may leverage mutually authenticated SSL protocols to transmit the decrypted document back to the printer and update the document's SRC in some embodiments. This may prevent a compromised printer or a printer whose QSM score has dropped below the required level from being able to bypass security measures for the document. In the verification 2500 of FIG. 25, a QSM enabled laptop 2510 may attempt to print a protected document. The SRC for the laptop 2510 and the document and an identity of the laptop 2410 and/or laptop user may be sent 2540 to a QSM enabled printer 2530. The SRC for the laptop 2510, the SRC for the printer 2530, the identity of the laptop 2410 and/or laptop user, the identity of the printer 2530, and the document may be sent to a QSM authorizer 2520 for verification 2550. The QSM authorizer 2520 may examine the document requirements and certificates and determine that the security levels of the laptop 2510 and printer 2530 are high enough and that the laptop 2410, printer 2530, and/or user are on the ACL. Therefore, permission to print the document may be granted 2560.

### QSM Document Control Hardware Examples

Hardware designed to create or process documents may be configured to directly handle QSM Protected Documents. For example, printers, imaging devices, and fax machines may all be configured to natively support QSM Document Control. A simple implementation of anti-tamper may be a mechanism configured such that an attempt to access the processing area of a printer would render the secure storage area (where the BSSC and SRC are stored) unusable.

Specialized QSM devices may include a secure processor and storage area with tamper resistance security measures. An example secure processor and storage area which may be suitable for use in a QSM device is disclosed in U.S. patent application Ser. No. 14/523,577, entitled “Autonomous Control Systems and Methods,” which is incorporated by reference herein. The secure processor may provide a physical layer of security including monitoring and action modules configured to constantly analyze connection states in real time between any number of devices or systems and act against pre-programmed out of bounds states. Using the secure processor to monitor for QSM protected documents may be a secure method to filter out unauthorized attempts to access or process protected documents.

For example, printers (e.g., any device that produces a hard or physical representation of a digital image or document, such as copiers, printers, fax machines, registers, etc.) may be QSM enabled. QSM document control may allow the protected document itself to carry and maintain the security controls within the document. QSM enabled printers may handle QSM protected documents by providing the document and the printer BSSC to the associated authorizer. After the authorizer has confirmed that the device is allowed to print the document, the authorizer may leverage mutually authenticated SSL protocols to transmit the decrypted document back to the printer and update the document's SRC. Alternately, if the printer has its own asymmetric key pair, the authorizer may encrypt the document with the printer's public key and transmit the document to the device. The printer's secure processor may then decrypt and print the document and clear the document off the device.

In some embodiments, printers may have secured segmented storage. Secure print jobs may be printed without being monitored and then collected by the user after they enter the required pin (or use a physical key) to unlock the storage tray. In some embodiments, printers may be configured to embed an invisible watermark, for example indicating the user and printer that printed the hardcopy. This may allow leaked documents to be tracked back to their origins. In some embodiments, printers may leverage specialized paper and/or inks which may react to the bright light of scanners and copiers, causing the originals (and any copies) to become unreadable.

Imaging devices (e.g., any device that captures an image and generates a file containing the image, such as digital cameras; fax machines, scanners/copiers, and medical imagers such as MRI, X-RAY and CT scanners) may also be QSM enabled. QSM enabled digital imaging devices may automatically generate protected documents. Users may be able to protect a single document and/or or an entire “session” automatically, causing the imaging device to encrypt the images as soon as they are taken. A “session” may last either until the user chooses to end the QSM session or until the imaging device is powered off or goes to sleep, for example. QSM imaging devices may be registered with an authorizer, allowing the user to generate the necessary public and private key pairs. For example, the imaging device may encrypt images (and optionally metadata) with the public key registered to the device. This may allow only the user to access the images until such time they decide to authorize additional users or devices. Besides being useful for securing images, QSM enabled images may assist users in maintaining copyright and licensing protection and proving ownership of their work.

Communication devices such as fax machines may also be QSM enabled. QSM enabled fax machines may allow shared fax machines (such as those found in offices or a commercial office services retail location) to securely send and receive documents. As part of the fax negotiation process, both machines may present their BSSC. If either of the devices does not have a BSSC, or the BSSC does not have a high enough score, the devices may either reject the connection or allow the user to fallback to a standard fax protocol. The user or an administrator may control this behavior.

When sending a fax from a QSM enabled fax machine, the process may proceed as follows. The user may enter the recipient phone number along with either a pre-shared PIN or the recipient's public QSM certificate. The user may scan the cover page and the protected document.

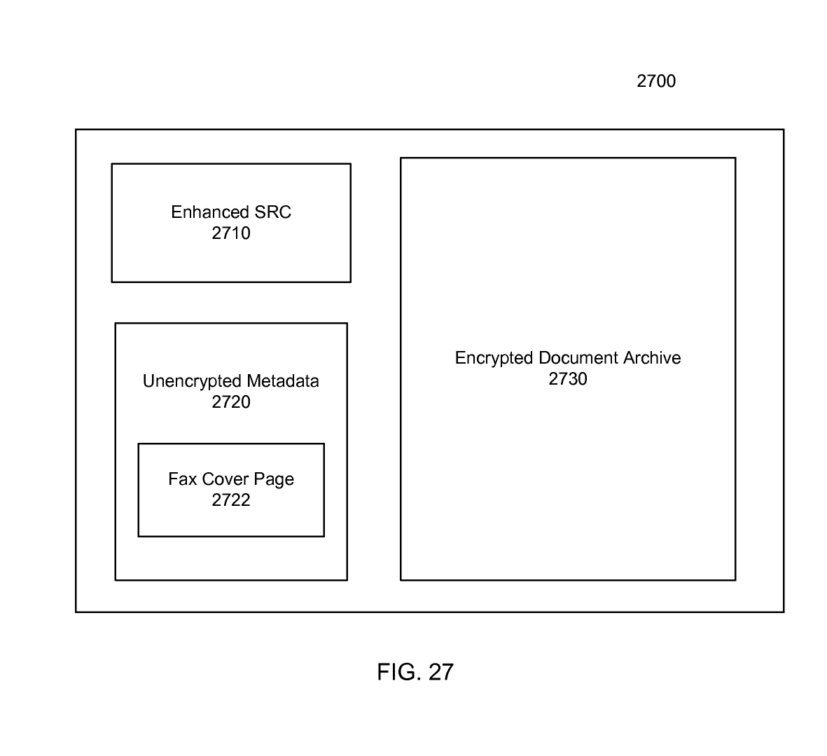

When receiving faxes, the QSM enabled fax machine may save the faxes as QSM protected documents. FIG. 27 is a protected document 2700 according to an embodiment of the invention. In this example document, the cover page 2722 may not be encrypted, allowing someone to understand how the document should be distributed. The cover page 2722 may be stored at the same level as the SRC 2710 and other unencrypted metadata 2720. A confirmation page may be generated which may provide timestamp, page count, and/or resolution details. The confirmation page may be useful for ensuring the entire fax had been received without revealing details of the fax itself The confirmation page may also be leveraged for billing purposes. The contents of the faxed document 2730 may either be encrypted with the user supplied PIN or the user's public key obtained from the authorizer. Faxes may be stored as encrypted protected documents until the intended recipient could prove ownership either through the presentation of the correct private key or pre-shared PIN. Only after ownership has been established may the fax machine allow the document to be printed. It may also be possible to copy the protected document to a USB stick (either QSM or non-QSM enabled) or other storage device so ownership may be established using another system.

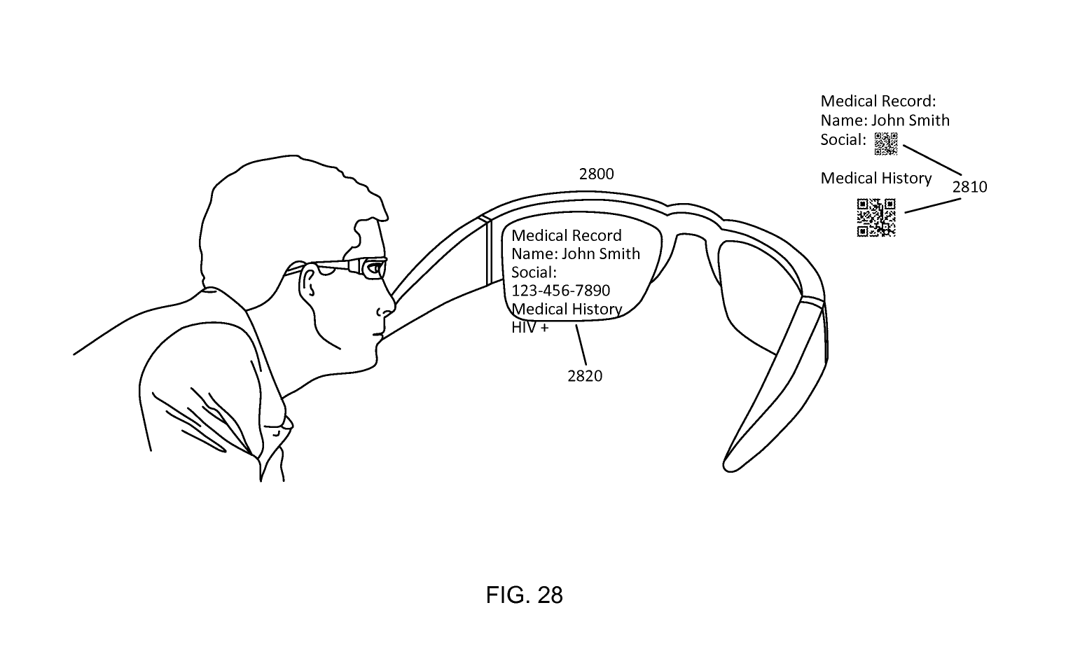

Hardware designed to create or process documents may be designed or retrofitted to directly handle protected documents. For example, specialized lenses (e.g., glasses, goggles, or view screens) may be provided, such as QSM-enhanced lenses that have input and output capabilities via physical or wireless connection to a computer that physically modifies the optical properties of the lenses or coordinates with the computer to partially display information on the lens and partially on a specialized monitor or printed page, in such a manner where both lens and monitor or specialized printed medium are required to be able to render the protected information. FIG. 28 is an example lens system 2800 according to an embodiment of the invention. These lenses may require some form of biometric information (such as a retinal scan) to unlock the cert (such as a QSM cert). This cert may be used to establish a mutually authenticated cryptographically secure channel where part or all of the protected data is displayed on the lens, and/or part or all of the protected data is displayed on the monitor or printed page. A simple version of this may be similar to the way that 3D movies are rendered, where special glasses are required to clearly view a stereoscopic image. In another version, such as the example of FIG. 28, a code 2810 may be provided in place of the protected data. The lenses 2800 may then receive the protected data directly in encrypted form and decrypt and display the protected data 2820 for the authorized user. Should the user remove the glasses or otherwise “break” the secure connection, then biometric identity verification may be required to reestablish the secure connection. To guard against “reply” biometric attacks, two-factor authentication may be used in addition to supplying a biometric token. For instance, in addition to providing a retina or fingerprint scan, the user may also be presented with a visual or audio challenge requiring specific movements or responses to verify identity.

Similar to imaging, documents created on a computer may be protected at creation and similar to portion marking in a classified document, each element, paragraph, image, HIPAA item, RSI, etc. may be identified and “tagged” appropriately. These elements may then be controlled through the ACL maintained within the enhanced SRC. Likewise, fields in a database or a digital form may be identified, and any information entered may automatically be protected by that form or record's ACL. The protected information may be maintained and carried with the document from that point forward.

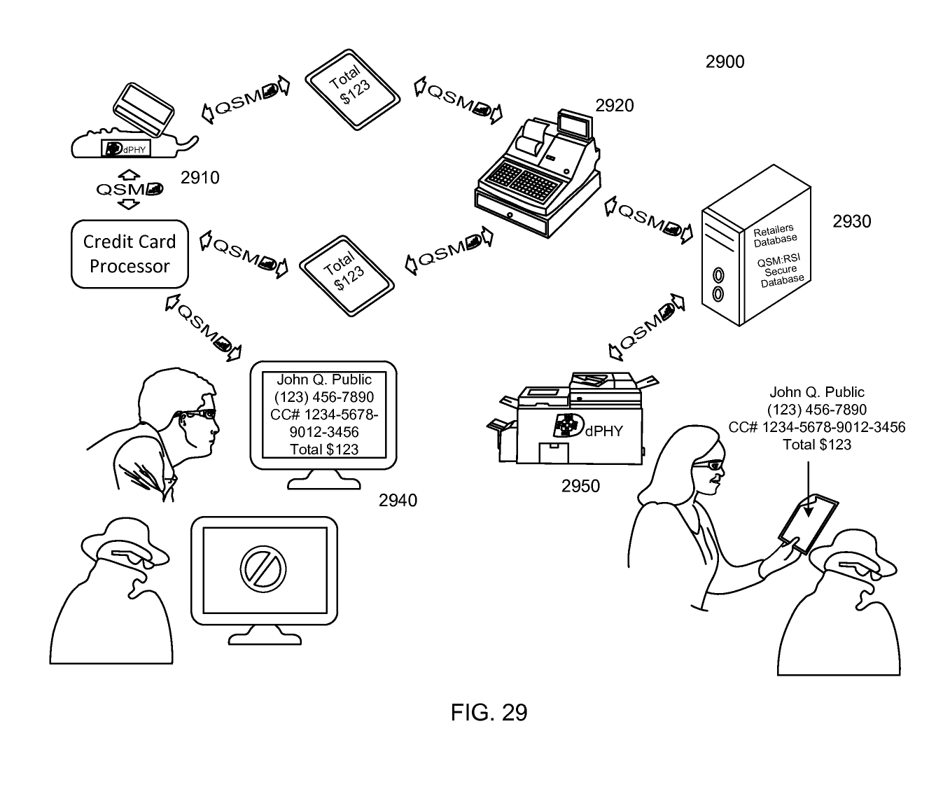

Point of Sale Devices (POSD) may be modified to protect documents, so scanning a credit card or accepting payment from some other device may not expose the RSI to an unauthorized individual or device. The POSD may have an isolated and encrypted secure storage area containing a QSM certificate to guarantee to the customer and the retailer that the device has not been tampered with and/or is genuine. For example, FIG. 29 is a secure transaction ecosystem 2900 according to an embodiment of the invention. An example POSD may include a credit card processor 2910 and/or cash register 2920. These devices may use QSM as described above to protect credit card data. When an authorizer 2930 confirms that a QSM certificate of a display device (e.g., computer 2940 and/or printer 2950) meets a rule for displaying sensitive credit card data, display of the data may be permitted, while unauthorized devices may be denied access to the data. This may protect the credit card RSI from theft or fraud.

Protection of documents may be extended to physical cards, such as credit cards, government IDs, and access badges that contain RSI. Information may be stored in a protected form on physical media, so if the card is lost, stolen, or copied, it may not provide access to the RSI. Furthermore, to ensure that the card is authentic, some form of cryptographic watermark, tag, or identifier may be embedded into the card that links the card issuer and the identity of the individual to which the card was issued.

Plug-ins or add-ons may be applied to corporate mail servers, mail clients, web servers, web browsers, and other applications commonly used to transmit, view, or process sensitive data. These plug-ins may enforce QSM controls on data based upon the SLDC. The plug-ins may prevent employees from sending (either purposefully or accidentally) sensitive information without first properly securing it. For instance, a social security number or credit card number typed into an e-mail may automatically be protected and routed to a QSM-enabled application or secure mail application. In some embodiments, specific types of information typed into documents (e.g., social security numbers) may be detected automatically and cause the program to prompt a user to apply a certain level of protection because that type of information is present in the document.

Specialized monitors may be used for processing protected documents. These monitors may have a system-modifiable electroluminescent (or similar) glass or filter which may alter or mask protected documents in a manner that prohibits an unauthorized user from viewing or photographing it. In such a monitor, non-RSI may always be visible on the screen, but RSI content may be invisible to unauthorized users. The monitor may have built-in biometric or proximity detection such that it will only display protected documents when an authenticated user is present. For a proximity tag implementation, a transmitting device (such as an NFC tag built into an access badge) may have a user's identity information that may be securely transmitted to the monitor. The monitor may present challenge questions to further verify identity before displaying protected documents, for example. As a further step, a verification code may also be sent to a user's mobile phone, and the user may be required to enter the code before starting a viewable protected session. The sessions may end when proximity is no longer detected. In another embodiment, an authorized user wearing a specialized lens system that is cryptographically authenticated with the system may be required to process or modify the displayed information on the monitor to properly render the protected documents. Alternately, the protected documents may be sent to the lenses, and a synchronization process may align the displayed page with the field of view of the lens such that the protected documents projected onto the lenses would be in line with non-protected data displayed on the monitor. In some embodiments of a monitor-only implementation, a combination of visible and non-visible components may be displayed which may cause an automatic digital camera to increase its shutter speed to a point where the shutter is quicker than the rendering of the document (i.e., the document may be presented in two or more “interlaced” or “phased” portions that may be blended by a viewer's brain into a single image but captured incomplete by the photo). Should the camera be manually set to a slower shutter speed, the non-protected components may over saturate the image, again making the RSI unreadable.

### Secure Document Control Implementation Examples

In order to reduce costs, enterprises and/or individuals often share printers. This may result in sensitive information being left on printers, exposing the information to individuals who should not have access to it. QSM document control combined with specialized QSM printers may prevent access to printed material except by the authorized individual. Printers may either wait to print the document until the user is at the printer (by requiring a PIN) or store larger print jobs in secured trays only accessible with the proper PIN or physical key. QSM document control may also provide non-repudiation of print jobs. Customers may be unable to dispute how many pages they printed in a given period of time since printer logs may be cryptographically backed.

QSM document control may allow commercial printer services to provide customers with quantifiable security. Customers may not need to worry about an employee stealing soft copies of their material, since the material may be secured so only the printers at the service could access them. Even if an employee stole the file, the authorizer may prevent the employee from actually doing anything with it. Furthermore, while a malicious printing service employee could try to steal physical copies of documents, the likelihood of this happening may be greatly reduced. QSM controls may limit the number of copies that could be printed, causing the malicious employee to need to physically take a hard copy to another location to copy. In addition, the store may leverage physically controlled printers to prevent employees from accessing printed materials without the intended recipient being present.

QSM document control may be leveraged to secure health records in accordance with HIPAA requirements. Documents may be broken into differing levels of access (similar to government compartmentalization) based upon an actual need to know. Insurance companies may be granted access to see that certain tests had actually been performed, but not the results of the tests, for example. QSM protected documents may be prevented from being opened on untrusted computers. Doctors may be able to access their e-mail from personal computers, but mayneed to be on a trusted computer or even physically at the hospital on their secure QSM network to access sensitive patient records or attachments.

QSM enabled closed-circuit television (CCTV) imaging devices may automatically encrypt photographs or video feeds, preventing them from being viewed by unapproved users. Imaging devices may be configured to only allow certain users access or restrict access to certain computers. Besides providing secure transmissions of CCTV feeds, QSM document control may also provide cryptographic evidence of where and when photographs were taken. This may prove useful for criminal or civil legal cases where an image's authenticity comes into question.

Similar to securing CCTV feeds, the fact the authenticity of a QSM document is cryptographically provable may be useful when analyzing logs secured with QSM document control or when using them as legal evidence. Each log entry may be individually protected automatically, ensuring logs are not modified or altered. Note that while QSM document control may maintain document authenticity, it may not directly maintain the accuracy of the logs. However, since the QSM score of the device at the time a log entry was created may be known, the relative integrity of the log may also be known.

Entities, such as government entities for example, may use multiple security classifications that may be leveraged to determine which individuals have access to which information. QSM document control may allow documents to maintain their security regardless of their environment. A document's classification level may prevent it from being viewed on machines that have not been authorized access. For example, a top secret document may not be accidently viewed on a machine only rated for secret information. This may protect against inadvertent leakage and deliberate compromise by insider threats. A QSM-enabled machine may not allow a user to create an unprotected version of a document. Consequently, a non-QSM machine may not be able to decrypt the information, as only the QSM authorizer may have the required keys. For classified networks and information, the QSM authorizer may only be accessible from the classified network, meaning the document may not be decrypted if it is removed from the classified network. Due to the sensitivity of classified documents, QSM authorizers may enforce both QSM machine and QSM user/group authorization. Users may have certificates associated with their logins which may be leveraged by QSM authorizers to verify whether the user has the necessary clearance level.

For the case of viewing physical documents with protected RSI, consider a document such that the non-RSI is viewable in plain text but any protected RSI is only seen as an encrypted string, a “QR” code as shown in the example of FIG. 26, or an invisible optical signature. Devices such as smart phones or tablets may be used to view the document and digitally decode, overlay, and display the protected RSI in a form of “augmented reality” for documents. A smartphone or tablet may be biometrically tied to a user through a fingerprint sensor or other security device. The smartphone or tablet may not unlock unless the user is authenticated such that the device provides identity verification (e.g., through positive fingerprint identification). A custom QR reader application may use the device's camera to view the protected physical document and search for the encoded or encrypted RSI. Embedded into the application is a SRC and ACL may verify that the user can see the protected RSI before decoding it. After verifying permissions for the user, the application may use character recognition (OCR) or QR scanning algorithms to read in the protected RSI and overlay decoded/decrypted RSI in place of or on top of encoded/encrypted RSI on the screen. If the SRC permissions allow, a user may read the document into the app for editing, storage, or transport. In another embodiment, the wearable lenses described above may also implement this augmented reality scheme.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system for controlling access to a document comprising:
a security module including a processor and physical memory, the processor constructed and arranged to:
receive a certificate comprising a security score from a device attempting to access a portion of a secured electronic file;
compare the security score to a file access rule for the secured electronic file in the memory to determine whether the security score satisfies the file access rule;
when the security score satisfies the file access rule, provide access to the portion of the secured electronic file; and
when the security score does not satisfy the file access rule, deny access to the portion of the secured electronic file.

2. The system of claim 1, wherein the processor is further constructed and arranged to:
determine whether the device and/or a user of the device is permitted to access the file based on access control information stored in the memory;
when the device and/or user of the device is permitted to access the file, provide access to the portion of the secured electronic file; and
when the device and/or user of the device is not permitted to access the file, deny access to the portion of the secured electronic file.

3. The system of claim 1, wherein the processor is further constructed and arranged to secure the secured electronic file.

4. The system of claim 3, wherein securing the secured electronic file comprises:
encrypting the electronic file;
generating a public/private key pair; and
storing the private key in the memory.

5. The system of claim 1, wherein the processor is further constructed and arranged to generate the file access rule.

6. The system of claim 5, wherein generating the file access rule comprises:
identifying a portion of the secured electronic file to be secured; and
defining a required security score for accessing the identified portion.

7. The system of claim 5, wherein generating the file access rule comprises:
identifying a plurality of portions of the secured electronic file to be secured; and
defining a required security score for accessing each of the identified portions, wherein at least two of the identified portions have different required security scores.

8. The system of claim 1, wherein the security score comprises a current normalized security score.

9. The system of claim 1, wherein the file access rule comprises a security rating index.

10. The system of claim 1, wherein providing access to the portion of the secured electronic file comprises producing indicia of acceptable security for the device.

11. The system of claim 1, wherein the secured electronic file comprises a document.

12. The system of claim 1, wherein providing access to the portion of the secured electronic file comprises allowing viewing, editing, printing, copying, or transmitting the portion of the secured electronic file, or a combination thereof.

13. The system of claim 12, wherein the access control information provides different permissions for at least two of viewing, editing, printing, copying, and transmitting the portion of the secured electronic file.

14. The system of claim 1, wherein denying access to the portion of the secured electronic file comprises blocking viewing, editing, printing, copying, or transmitting the portion of the secured electronic file, or a combination thereof.

15. The system of claim 13, wherein the access control information provides different permissions for at least two of viewing, editing, printing, copying, and transmitting the portion of the secured electronic file.

16. A method for controlling access to a document comprising:
receiving, with a processor of a security module including the processor and physical memory, a certificate comprising a security score from a device attempting to access a portion of a secured electronic file;
comparing, with the processor, the security score to a file access rule for the secured electronic file in the memory to determine whether the security score satisfies the file access rule;
when the security score satisfies the file access rule, providing access, with the processor, to the portion of the secured electronic file; and
when the security score does not satisfy the file access rule, denying access, with the processor, to the portion of the secured electronic file.

17. The method of claim 16, further comprising:
determining, with the processor, whether the device and/or a user of the device is permitted to access the file based on access control information stored in the memory;
when the device and/or user of the device is permitted to access the file, providing access, with the processor, to the portion of the secured electronic file; and
when the device and/or user of the device is not permitted to access the file, denying access, with the processor, to the portion of the secured electronic file.

18. The method of claim 16, further comprising securing, with the processor, the secured electronic file.

19. The method of claim 18, wherein securing the secured electronic file comprises:
encrypting the electronic file;
generating a public/private key pair; and
storing the private key in the memory.

20. The method of claim 16, further comprising generating, with the processor, the file access rule.

21. The method of claim 19, wherein generating the file access rule comprises:
identifying a portion of the secured electronic file to be secured; and
defining a required security score for accessing the identified portion.

22. The method of claim 19, wherein generating the file access rule comprises:
identifying a plurality of portions of the secured electronic file to be secured; and
defining a required security score for accessing each of the identified portions, wherein at least two of the identified portions have different required security scores.

23. The method of claim 16, wherein the security score comprises a current normalized security score.

24. The method of claim 16, wherein the file access rule comprises a security rating index.

25. The method of claim 16, wherein providing access to the portion of the secured electronic file comprises producing indicia of acceptable security for the device.

26. The method of claim 16, wherein the secured electronic file comprises a document.

27. The method of claim 16, wherein providing access to the portion of the secured electronic file comprises allowing viewing, editing, printing, copying, or transmitting the portion of the secured file, or a combination thereof.

28. The system of claim 27, wherein the access control information provides different permissions for at least two of viewing, editing, printing, copying, and transmitting the portion of the secured electronic file.

29. The method of claim 16, wherein denying access to the portion of the secured electronic file comprises blocking viewing, editing, printing, copying, or transmitting the portion of the secured file, or a combination thereof.

30. The system of claim 29, wherein the access control information provides different permissions for at least two of viewing, editing, printing, copying, and transmitting the portion of the secured electronic file.

31. A system for controlling access to a document comprising:
a file processing device comprising a device security module including a device processor and device physical memory, the device processor constructed and arranged to:
transmit a secured electronic file; and
transmit a certificate comprising a security score for the file processing device in order to request access to the secured electronic file; and
an authorizer comprising an authorizer security module including an authorizer processor and authorizer physical memory, the authorizer processor constructed and arranged to:
receive the certificate and the secured electronic file;
compare the security score to a file access rule for the secured electronic file in the authorizer memory to determine whether the security score satisfies the file access rule;
when the security score satisfies the file access rule, provide access to the portion of the secured electronic file by transforming the secured electronic file into an accessible version and sending the accessible version to the file processing device; and
when the security score does not satisfy the file access rule, deny access to the portion of the secured electronic file.

32. The system of claim 31, wherein the authorizer is further constructed and arranged to:
determine whether the device and/or a user of the device is permitted to access the file based on access control information stored in the memory;
when the device and/or user of the device is permitted to access the file, provide access to the portion of the secured electronic file; and
when the device and/or user of the device is not permitted to access the file, deny access to the portion of the secured electronic file.

33. The system of claim 31, wherein the authorizer processor is further constructed and arranged to secure the secured electronic file.

34. The system of claim 33, wherein securing the secured electronic file comprises:
encrypting the electronic file;
generating a public/private key pair; and
storing the private key in the memory.

35. The system of claim 31, wherein the authorizer processor is further constructed and arranged to generate the file access rule.

36. The system of claim 35, wherein generating the file access rule comprises:
identifying a portion of the secured electronic file to be secured; and
defining a required security score for accessing the identified portion.

37. The system of claim 35, wherein generating the file access rule comprises:
identifying a plurality of portions of the secured electronic file to be secured; and
defining a required security score for accessing each of the identified portions, wherein at least two of the identified portions have different required security scores.

38. The system of claim 31, wherein the security score comprises a current normalized security score.

39. The system of claim 31, wherein the file access rule comprises a security rating index.

40. The system of claim 31, wherein providing access to the portion of the secured electronic file comprises producing indicia of acceptable security for the device.

41. The system of claim 31, wherein the secured electronic file comprises a document.

42. The system of claim 31, wherein the device processor is further constructed and arranged to:
receive the accessible version; and
perform processing associated with viewing, editing, printing, copying, or transmitting the accessible version, or a combination thereof.

43. The system of claim 42, wherein the access control information provides different permissions for at least two of viewing, editing, printing, copying, and transmitting the portion of the secured electronic file.

44. The system of claim 31, wherein the secured electronic file is stored in the device memory.

45. The system of claim 31, further comprising a second file processing device comprising a second device security module including a second device processor and second device physical memory; wherein:
the second device processor is constructed and arranged to:
select the secured electronic file for access;
direct the device to access the secured electronic file; and
transmit a second certificate comprising a second security score for the second file processing device in order to request access to the secured electronic file; and
the authorizer processor is further constructed and arranged to:
receive the second certificate;
compare the second security score to the file access rule for the secured electronic file in the authorizer memory to determine whether the second security score satisfies the file access rule;
when the security score and the second security score both satisfy the file access rule, provide the access to the portion of the secured electronic file; and
when at least one of the security score and the second security score does not satisfy the file access rule, deny access to the portion of the secured electronic file

46. The system of claim 45, wherein the device processor is further constructed and arranged to:
receive the second certificate from the second device processor; and
transmit the second certificate along with the certificate.

47. The system of claim 45, wherein:
the second device processor is further constructed and arranged to transmit the secured electronic file; and
the device processor is further constructed and arranged to receive the secured electronic file before transmitting the secured electronic file.

48. The system of claim 45, wherein the secured electronic file is stored in the device memory, the second device memory, or both.

49. A method for controlling access to a document comprising:
transmitting, with a device processor of a device security module including the device processor and device physical memory, a secured electronic file;
transmitting, with the device processor, a certificate comprising a security score for the file processing device in order to request access to the secured electronic file;
receiving, with an authorizer processor of an authorizer security module including the authorizer processor and authorizer physical memory, the certificate and the secured electronic file;
comparing, with the authorizer processor, the security score to a file access rule for the secured electronic file in the authorizer memory to determine whether the security score satisfies the file access rule;
when the security score satisfies the file access rule, providing access, with the authorizer processor, to the portion of the secured electronic file by transforming the secured electronic file into an accessible version and sending the accessible version to the file processing device; and
when the security score does not satisfy the file access rule, denying access, with the authorizer processor, to the portion of the secured electronic file.

50. The method of claim 49, further comprising:
determining, with the authorizer processor, whether the device and/or a user of the device is permitted to access the file based on access control information stored in the memory;
when the device and/or user of the device is permitted to access the file, providing access, with the authorizer processor, to the portion of the secured electronic file; and
when the device and/or user of the device is not permitted to access the file, denying access, with the authorizer processor, to the portion of the secured electronic file.

51. The method of claim 49, further comprising securing, with the authorizer processor, the secured electronic file.

52. The method of claim 51, wherein securing the secured electronic file comprises:
encrypting the electronic file;
generating a public/private key pair; and
storing the private key in the memory.

53. The method of claim 49, further comprising generating, with the authorizer processor, the file access rule.

54. The method of claim 53, wherein generating the file access rule comprises:
identifying a portion of the secured electronic file to be secured; and
defining a required security score for accessing the identified portion.

55. The method of claim 53, wherein generating the file access rule comprises:
identifying a plurality of portions of the secured electronic file to be secured; and
defining a required security score for accessing each of the identified portions, wherein at least two of the identified portions have different required security scores.

56. The method of claim 49, wherein the security score comprises a current normalized security score.

57. The method of claim 49, wherein the file access rule comprises a security rating index.

58. The method of claim 49, wherein providing access to the portion of the secured electronic file comprises producing indicia of acceptable security for the device.

59. The method of claim 49, wherein the secured electronic file comprises a document.

60. The method of claim 49, further comprising:
receiving, with the device processor, the accessible version; and
performing, with the device processor, processing associated with viewing, editing, printing, copying, or transmitting the accessible version, or a combination thereof.

61. The system of claim 60, wherein the access control information provides different permissions for at least two of viewing, editing, printing, copying, and transmitting the portion of the secured electronic file.

62. The method of claim 49, wherein the secured electronic file is stored in the device memory.

63. The method of claim 49, further comprising:
selecting, with a second device processor of a second device security module including the second device processor and second device physical memory, the secured electronic file for access;
directing, with the second device processor, the device to access the secured electronic file;
transmitting, with the second device processor, a second certificate comprising a second security score for the second file processing device in order to request access to the secured electronic file;
receiving, with the authorizer processor, the second certificate;
comparing, with the authorizer processor, the second security score to the file access rule for the secured electronic file in the authorizer memory to determine whether the second security score satisfies the file access rule;
when the security score and the second security score both satisfy the file access rule, providing, with the authorizer processor, the access to the portion of the secured electronic file; and
when at least one of the security score and the second security score does not satisfy the file access rule, denying, with the authorizer processor, access to the portion of the secured electronic file.

64. The method of claim 63, further comprising:
receiving, with the device processor, the second certificate from the second device processor; and
transmitting, with the device processor, the second certificate along with the certificate.

65. The method of claim 63, further comprising:
transmitting, with the second device processor, the secured electronic file; and
receiving, with the device processor, the secured electronic file before transmitting the secured electronic file.

66. The method of claim 63, wherein the secured electronic file is stored in the device memory, the second device memory, or both.

67. A security evaluation method comprising:
receiving, with a processor, a breakdown of a system into one or more components;
evaluating, with the processor, each of the components to ascribe a security score to each of the components;
generating, with the processor, a composite security score for the system based on the security scores;
generating, with the processor, a rate of decay measure characterizing a probabilistic security degradation of the system;
applying, with the processor, the rate of decay measure to the composite security score to obtain a current composite security score;
supplying, with the processor, the current composite security score;
selectively producing indicia of acceptable security for the system based upon the comparison of the current composite security score to a security rating index; and
controlling, with the processor, permissions to a digital file or a collection of digital files based on the value of the indicia of acceptable security.

68. The method of claim 67, further comprising creating a compressed archive containing the digital file or the collection of digital files and a security requirements certificate including the indicia of acceptable security, a set of permission key-value pairs, and validation data for validating the base security score certificate of an application on the system.

69. The method of claim 67, further comprising applying an encrypted digital signature, including an indicia of authenticity and an indicia of the author, to the digital file or each of the digital files in the collection of digital files, wherein the digital signature is applied upon file creation and updated or applied as a second encrypted digital signature each time there is a change to the digital file or the collection of digital files.

70. The method of claim 67, further comprising controlling access and permissions to part of a digital file based on the value of the indicia of acceptable security, including selectively displaying part of the file or visually covering displayed portions of said file.

71. The method of claim 67, further comprising enforcement of attributes, settings, and permissions to permit printing, copying, displaying, editing, and/or transmitting of a digital file based on the value of the indicia of acceptable security.

72. The method of claim 67, further comprising automatic enforcement of security controls specifying attributes, settings, and permission associated with a document to a physical instantiation of the document.

73. The method of claim 67, further comprising relaying the security attributes specified in the file to a hardware device, causing the device to implement the associated physical security methods.

74. A security evaluation system comprising:
a processor configured to:
receive a breakdown of a system into one or more components;
evaluate each of the components to ascribe a security score to each of the components;
generate a composite security score for the system based on the security scores;
generate a rate of decay measure characterizing a probabilistic security degradation of the system;
apply the rate of decay measure to the composite security score to obtain a current composite security score;
supply the current composite security score; and
selectively produce indicia of acceptable security for the system based upon the comparison of the current composite security score to a security rating index; and
a document processing device in communication with the processor and configured to control permissions to a digital file or a collection of digital files based on the value of the indicia of acceptable security.

75. The system of claim 74, wherein the processor is further configured to create a compressed archive containing the digital file or the collection of digital files and a security requirements certificate including the indicia of acceptable security, a set of permission key-value pairs, and validation data for validating the base security score certificate of an application on the system.

76. The system of claim 74, wherein the processor is further configured to apply an encrypted digital signature, including an indicia of authenticity and an indicia of the author, to the digital file or each of the digital files in the collection of digital files, wherein the digital signature is applied upon file creation and updated or applied as a second encrypted digital signature each time there is a change to the digital file or the collection of digital files.

77. The system of claim 74, wherein the document processing device is further configured to control access and permissions to part of a digital file based on the value of the indicia of acceptable security, including selectively displaying part of the file or visually covering displayed portions of said file.

78. The system of claim 74, wherein the document processing device is further configured to enforce attributes, settings, and permissions to permit printing, copying, displaying, editing, and/or transmitting of a digital file based on the value of the indicia of acceptable security.

79. The system of claim 78, wherein the document processing device is further configured to enforce security controls specifying attributes, settings, and permission associated with a document to a physical instantiation of the document.

80. The system of claim 78, wherein the document processing device is further configured to relay the security attributes specified in the file to a hardware device, causing the device to implement the associated physical security methods.
